(19) United States
(12) Patent Application Publication
(10) Pub. No.: US 2003/0105816 A1
(43) Pub. Date: Jun. 5, 2003

(54) System and method for real-time multi-directional file-based data streaming editor

(76) Inventor: Dinkar Goswami, Potomac, MD (US)

Correspondence Address: VENABLE, BAETJER, HOWARD AND CIVILETTI, LLP, P.O. BOX 34385, WASHINGTON, DC, 20043-9998, US

(21) Appl. No.: 10/223,611

(22) Filed: Aug. 20, 2002

Related U.S. Application Data
(60) Provisional application No. 60/313,027, filed on Aug. 20, 2001.

(51) Int. Cl. G06F 15/16

(52) U.S. Cl. 709/204; 709/205; 709/203

(57) ABSTRACT

This invention provides a system and method for multiple users to simultaneously access selected files during an online session. Each of the users has read access to each of the other users' selected files Each user can edit each of the other users' files, although only a single user may edit any file at a given point in time. The invention synchronizes editing control among the users. Each time a user edits a file, the edit is automatically cascaded to all session participants.

### CROSS-REFERENCE TO RELATED APPLICATIONS

This application claims the benefit of U.S. Appl. No. 60/313,027, filed Aug. 20, 2001, and U.S. Appl. No. 09/829,908, filed Apr. 11, 2001, each of which is commonly owned by the owner of this application and is incorporated by reference herein.

### BACKGROUND OF THE INVENTION

1. Field of the Invention

The present invention relates generally to data processing systems, and more specifically to systems and methods that provide real-time multidirectional file-based data streaming editors.

2. Statement of the Prior Art

The Internet is increasingly used as a collaboration tool among groups of users who are physically separated (i.e., not located in the same geographic area). Collaboration generally includes multi-user access to a file. It is often desirable for the collaborating parties to have joint editing and viewing capabilities. For example, remote Internet users may desire to participate in virtual meetings, distance learning, virtual seminars, or online conferencing and the like. The current marketplace offers various systems, which allow multiple users to collaborate over a network. However, many of these conventional systems do not provide safeguards that are useful to protect confidential information on a desktop, while providing complete multi-user access to one or more files.

At a basic level, e-mail and chat systems (e.g., AOL Instant Messenger® by America Online, Inc.) allow users to exchange information, ideas and files over a network. Both of these types of systems have obvious shortcomings. An e-mail message, for example, is sent from one user to another as a series of packets routed through a network. These packets are not necessarily sent over the same path and, therefore, may not arrive at the destination node in order. Once all of the packets have been received at the destination node, the packets are then re-ordered and delivered to the intended recipient. This process may take anywhere from a couple of seconds to several hours. Accordingly, it will be appreciated that their prolonged transmission time and failure to support real-time collaboration limit such conventional e-mail systems. Chat systems provide a more real-time manner for users to exchange text messages. However, collaboration may prove more valuable when users are able to exchange and compare files in real-time.

Some systems that allow remote users to exchange and compare files in real-time do exist. These systems can generally be grouped as either desktop sharing and capturing applications, or whiteboard applications. Whiteboard applications provide a common work area where multiple remote users can input data, which is reflected to all other users participating in a session. The users' input is generally in the form of annotations. Desktop sharing and capturing applications allow multiple users to access the contents of an initiating computer, or of an application. Conventional desktop sharing and whiteboard application systems are subject to several shortcomings, some of which are outlined below.

First, these conventional systems generally either: (1) provide users with access to all of the files stored on the hard drive, in a specific directory of the initiating computer, or relative to a specific application on the initiating computer; or (2) only provide access to a single file. Additionally, many of the conventional systems fail to provide all of the users with capabilities to edit, print, save, etc. Even when all users are provided with complete editing capabilities, the user of the initiating machine generally has superior editing rights that preempt those of other users. This can potentially decrease the value of the collaboration process. Additionally, such systems only allow a single copy of the file (i.e., the copy of the file that is on the initiating machine) to be modified, regardless of which user is performing the edit operations. Thus, even if a remote user edits the file, only the copy of this file that is located on the initiating computer can be saved. The users must transmit the modified file among themselves via, for example, e-mail, and each user will have to save the modified file outside of the desktop sharing and capturing application. Further, such systems usually limit the file sharing capabilities to a single file. Tools that do support simultaneous access to multiple files may require each user to manually position the file on the screens that they may be viewed. Further still, users can only view a file that has been opened in application that is supported by their local machines. Finally, conventional systems do not include a control transfer feature that allows one remote user to assign access rights to another remote user. Rather, such systems allow all remote users to access all files of an initiating computer.

Accordingly, a need exists for a tool that will allow multiple remote users to collaborate over a file, while overcoming the shortcomings of conventional systems.

### SUMMARY OF THE INVENTION

The present invention, in a preferred embodiment, provides an online, multi-directional file-based data streaming editor that allows multiple users to simultaneously compare, merge, and instantly edit files, while concurrently communicating with one another over a dedicated connection.

In accordance with an embodiment of the invention, an online file editing method is provided. The method includes creating a session that allows at least two users with simultaneous to access a file, where each user has access to a replica of the file, receiving from a user an edit instruction indicating a file edit, editing a replica of the file according to the edit instruction, and automatically cascading the file edit to each replica of the file.

In accordance with another embodiment of the invention, an online file editing method is provided. The method includes providing at least two users with simultaneous access to a file such that each user has access to a replica of the file, providing one of the at least two users with a capability to edit a local replica of the file, and automatically cascading the edit to all of the replicas of the file.

In accordance with yet another embodiment of the invention an online file editing method is provided. The method includes uploading the file from a first client to a server, providing to the first client and a second client simultaneous access to a replica of the file, a first replica and a second replica, respectively, receiving from one of the first client and the second client an edit command to edit one of the first replica and the second replica, editing the one of the first replica and the second replica of the file according to the edit command, and automatically editing or causing to be edited an other of the first replica and the second replica of the file according to the editing of the one of the first replica and the second replica of the file such that the editing is performed at a same location of the other of the first replica and the second replica of the file as it was performed in the one of the first replica and the second replica of the file.

In accordance with an embodiment of the invention a system to edit a file over a network is provided. The system includes a first client, which includes a first file and an editor that allows a user of the first client to access a replica of a second file, a second client that includes the second file and an editor that allows the second client to access a replica of the first file, and a server that provides the first client and the second client with simultaneous access to the replicas of the first and second files.

### BRIEF DESCRIPTION OF THE DRAWINGS

FIG. 1 depicts an exemplary computer network suitable for practicing the invention;

FIG. 2 depicts an exemplary flow diagram of the processing performed relative to this invention;

FIG. 2a depicts an exemplary screen shot of a form that can be used to create a session;

FIG. 2b depicts an exemplary screen shot of a page that can be used to upload a file from a participant's local drive to a server;

FIG. 3 depicts an exemplary screen layout of a virtual meeting space tool interface in a two user implementation in accordance with the present invention;

FIG. 3a depicts an exemplary screen shot of the screen layout depicted in FIG. 3;

FIG. 3b depicts an exemplary screen shot of the screen displays of both participants of a two-participant session in accordance with the present invention;

FIG. 4 depicts an exemplary screen shot of a multi-user interface;

FIGS. 5a-5d depict a flowchart illustrating the formation of a command string according to the present invention, which carries all of the information needed for a receiving editor to carry out the corresponding cascading operations;

FIG. 6 depicts a flowchart illustrating a module according to the present invention, which handles the processing of editor data when a user joins a session;

FIGS. 7a-7e depict a flowchart illustrating an execution scheme according to the present invention;

FIG. 8 depicts a flowchart illustrating a switch transfer phenomenon according to the present invention;

FIG. 9 depicts a flowchart illustrating a module according to the present invention in which each command string, ready to be sent out from the computer, is tagged with a unique number;

FIGS. 10a-10c depict a flowchart illustrating the processing of strings generated from one end which are destined to go to the buddy end;

FIG. 11 depicts a window illustrating a first interface, which depicts the current status of various Locked and Hide rights specified by the host for various users of the CURRENT DOCUMENT;

FIG. 12 depicts a window illustrating a second interface, which lets the host specify the rights with respect to selective locking and hiding of data of the current document;

FIG. 13 depicts a window illustrating a third interface, which lets the host specify the list of users who cannot view the edits done by a particular user;

FIG. 14 depicts a window illustrating a fourth interface, which shows the current choices of the host with respect to the hiding of edits of particular user from set of users;

FIG. 15 depicts a window illustrating a fifth interface, which lets the host specify the specific areas for insertions to be done by various users;

FIG. 16 depicts a window illustrating a sixth interface, which lets the host change the choice for the current Insert Area;

FIG. 17 depicts a window illustrating a message box used in accordance with the present invention;

FIG. 18 depicts a window illustrating a seventh interface, which will be presented to a user for whom the host has designated an insert area in an archived session document;

FIG. 19 depicts a window illustrating an eighth interface, which allows the host to specify the order in which users to put their insertions in an online manner;

FIG. 20 depicts a window illustrating a ninth interface, which shows the right hand side tab of Edit Rights;

FIG. 21 depicts a window illustrating a tenth interface, which will let the host do manual merge actions;

FIG. 22 is a data flow diagram, which depicts the various entities involved and the flow of information through the system according to the present invention;

FIG. 23 depicts a flowchart illustrating the process by which choices are sent to the editor;

FIG. 24 depicts a flowchart illustrating the way in which information travels from tabs through Switch Notes Conference Control to the editor and back for updating the information on the Edit Right Tabs;

FIG. 25 depicts a flowchart illustrating the way in which how information travels from tabs through Switch Notes Conference Control to the editor and back for updating the grid of the Edit Right→Give Edit Rights sub Tabs for the current Range;

FIG. 26 depicts a flowchart illustrating the way in which the EDTAB Command String is interpreted at the end of execution;

FIG. 27 depicts a flowchart illustrating the way in which the system of the present invention processes the creation of a void;

FIGS. 28a-28b depict a flowchart illustrating the process of Command String Filtering; and

FIG. 29 depicts a flowchart illustrating how the command string created due to any edit that an invitee does from now onwards will also go through a Command String filter to make sure that this command string is refreshed as per the contents of the Host document.

### DETAILED DESCRIPTION OF THE INVENTION

The present invention provides an interactive web-based communications tool, which serves as an online, multi-directional file based streaming editor. As such, this “virtual meeting space tool” allows multiple remote users to collaborate in real-time in order that the users can compare, merge and instantly edit a file, while simultaneously communicating with each other online. The merging or edit performed is immediately and simultaneously “cascaded” to all session users. The term “cascade,” as used herein, refers to automatically sending, or causing to be sent, an edit made in one file to all other files of a session and, thereby, ensuring that the edits are made in the same place in each of the files. The process of cascading thus may include receiving an edit command, creating one or more packets reflecting the changes made to the file, compressing and encrypting the packets, sending the packets to all replicas of the file that are included in a session, ordering the packets at a destination, and editing the file according, to the edit command, while ensuring that the edit is applied to an appropriate part of a file (i.e., the edit is made at a point of the file that corresponds to a point of the file where the edit was initially made). It is important to note that each session participant accesses a replica of a file, as distinguished from a copy of the file, which implies that an original exists and the others are copies of the original. According to this embodiment of the invention, each replica of the file is continuously updated and maintained consistent with each of the other replicas of the file, as modifications to a replica of a file are automatically cascaded to all other replicas of the file.

An “initiating” user initiates and session, which can be joined by one or more “invitees.” Collectively, the initiating user and invitee(s) are referred to as “participants.” Any of the session participants can be in control of a session and therefore function as a host of the session. Each session creates a dedicated link among session participants. The initiating user can create and delete a session. Invitees may join scheduled or ongoing sessions. Each session is uniquely identifiable according to information that is maintained by the system, for example, in a database. Further details on creating and joining sessions are provided below.

In particular, the invention allows multiple users to simultaneously access a file, while one of the multiple users can edit the file at a time. The system explicitly indicates which of the users has editing control at a given time, and allows the user with editing control to transfer such editing control to another user as desired (i.e., the host user can change throughout any given session). As a file is edited, changes are automatically and immediately cascaded to other session participants. Therefore, other session participants can view changes to a file in real-time. The virtual meeting space tool also provides additional editing features, such as, for example, tracking of changes, spell check, save, print, etc.

More specifically, the virtual meeting space tool provides a single interface that allows multiple network users to transfer files among one another, simultaneously open the files on each of the users' respective computers, edit the files, discuss the files via a one to one discussion interface, and browse the Internet while performing the above functions. The virtual meeting space tool interface includes an editor, a “switch” utility which allows a single user to retain control of a file at a given time, a chat area, a reference area, and an instant messaging utility, each of which is described further below. A user can therefore open a file and, in a parallel frame, open a file that has been received over the network. The interface provides an editor, which allows users to perform a variety of editing functions on a file.

The virtual meeting space tool according to the present invention provides various operational advantages that are not provided by conventional systems. For example, the virtual meeting space tool allows users to compare, merge and edit his or her own files, as well as the files of other session participants. Edits made to a file are transmitted simultaneously to all session participants, without a user initiating a “send” or “transmit” action. All session participants can save or print a file during the session. Further, during a session all participants may open, create or edit a file that cannot be viewed or otherwise accessed by other session participants. Such files can be merged with a shared file, regardless of the original owner of the shared file. The merged file is automatically transmitted to other session participants, as would a file that has been edited via the virtual meeting space interface. A “discussion area” section of the interface provides a chat function that allows participants of a session to discuss over files in real-time. The system further includes a manner for the users to designate one of the participants as having control over a file at a given time. The participant who has control can merge, edit, save, or print a file, and transfer control of the file in its full form to another session participant. Additionally, the invention allows an owner of a file to assign access permissions to replicas of the file. For example, a file owner can provide other session participants with permission to edit the file, but deny such participants permission to print or save the file, or vice versa. Further, in an embodiment, the invention can automatically compare two files and indicate the differences on the display.

The files may be in a variety of file or media formats, including, for example, text, hypertext markup language (HTML), graphics, AVI, etc. In some embodiments, the tool also enables users to browse the Internet while accessing shared files. In an embodiment of the invention, a user can open a file in one part of a screen and open in another part of the screen a file that was forwarded to the user during the current session, and work on both simultaneously. Similarly, in an embodiment of the invention, session participants can copy text and objects from each other's files and paste them in their own respective files, thereby editing their own files based on the simultaneous discussions and suggestions taking place through the discussion area without affecting the shared files. After editing, both users can save, print, or download the file and the discussion that occurred in the discussion area.

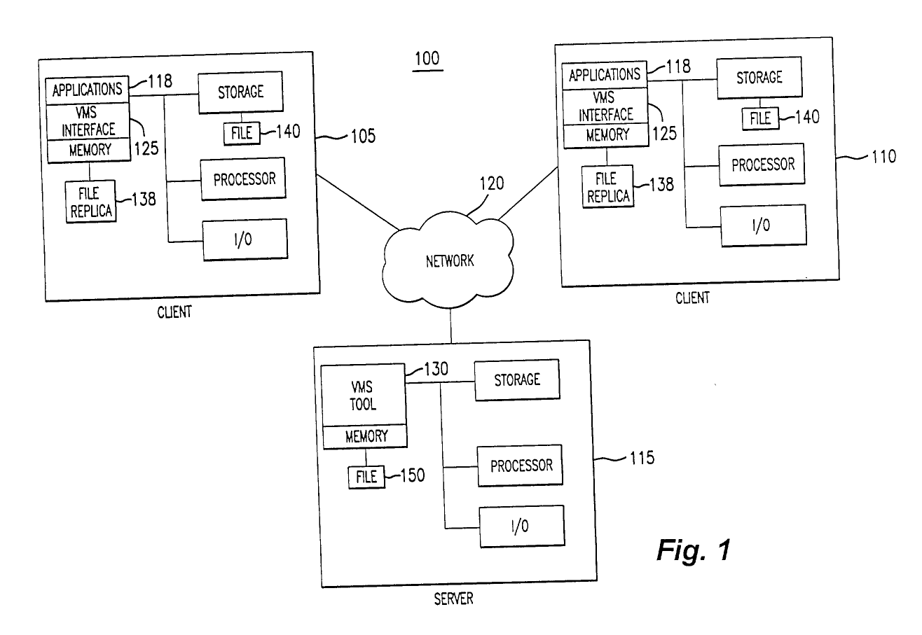

FIG. 1 depicts an exemplary computer network 100 that would be suitable for practicing the present invention. Network 100 includes a pair of clients 105 and 110, each of which communicates with one another and a server 115 via network 120. Clients 105 and 110 preferably correspond to desktop computers. Network 120 corresponds to any public or private network, such as the Internet, intranets, extranets, virtual private networks (VPN), local area networks (LAN), metropolitan area networks (MAN), or wide area networks (WAN).

Each of the clients 115 and 110 include the conventional components of a computer including memory, at least one processor, storage, and input and output devices. Those of ordinary skill in the art will appreciate that, while clients 105 and 110 have been depicted in FIG. 1 with a storage device, the present invention may be practiced with “dumb terminals” that do not include storage devices. Specifically, in such embodiments, no stored file is necessary. A document can be prepared, online or offline, or a user can join a session without contributing a file.

In accordance with one important aspect of the present invention, the systems and methods may be directed to computing means. Non-limiting examples of such “computing means” in this regard include: a general purpose computer; personal computers (PCs); web browsers; electronic mail (e-mail) clients and servers; network file and messaging servers; mainframes; Internet appliances; wireless telephones; pagers; personal digital assistants (PDAs); facsimile machines; digital still and video cameras; digital voice and video recorders; digital copiers or scanners; interactive television; a hybrid combination of any of the above computing means and an interactive television; and any apparatus comprising a processor, memory, the capability to receive input, and the capability to generate output.

The apparatus of the present invention also includes computing means programmed with software to operate the computing means in accordance with the invention. Non-limiting examples of such “computing means” in this regard include general-purpose computers and PCs of both client and server variety. Specific, non-limiting examples of such “computing means” in this regard include: web browsers; e-mail clients and servers; network file and messaging servers; mainframes; Internet appliances; wireless telephones; pagers; PDAs; facsimile machines; digital still and video cameras; digital voice and video recorders; digital copiers or scanners; interactive television; a hybrid combination of any of the above computing means and an interactive television; and any apparatus comprising a processor, memory, the capability to receive input, and the capability to generate output.

In accordance with another important aspect of the present invention, the article of manufacture of the invention comprises a computer-readable medium embodying code segments to control a computer to perform the invention. Non-limiting examples of a “computer-readable medium” in this regard include: a magnetic hard disk; a floppy disk; an optical disk, (e.g., a CD-ROM, a CD-R, and any disk compliant with DVD standards); a magneto-optical disk; a magnetic tape; a memory chip; a carrier wave used to carry computer-readable electronic data, such as those used in transmitting and receiving electronic mail or in accessing a network, such as the Internet or a local area network (“LAN”); and any storage device used for storing data accessible by a computer. Furthermore, non-limiting examples of “code segments” include software; instructions; computer programs; or any means for controlling a computer.

In accordance with yet another important aspect of the present invention, the systems and methods may be directed to documents. Non-limiting examples of such “documents” include word processing files, presentation files, spreadsheet files, graphics files, imaging files (e.g., bitmaps, GIF, JPEG, PCX/DCX, PDF, PNG, TIFF, XIF, etc.), computer-aided drafting (CAD) files, holographic files, two-dimensional files, three-dimensional files, or any other file produced by a software application.

The memory of each client 105 and 110 further includes one or more applications 118 that are used to create and open files that are transmitted and displayed according to the interface of the invention and a virtual meeting space (VMS) tool interface 125 that allows files to be opened, edited, and shared with session participants. The applications may include, for example, text, graphics, or spreadsheet applications, but they may also include other applications for processing audio, video, and computer-aided drafting (CAD) files. Session participants can upload locally stored files to server 115, which are downloaded to each session participant's computer when the file originator opens the file via the interface 125. An edit function of the virtual meeting space tool interface 125 provides a single user with permission to edit a file. All other session participants are only provided read access to the open session files. Each session participant has access to a local replica 138 of other session participants' files. The interface 125 will transfer edit control to another participant upon receiving an appropriate input. The virtual meeting space interface 125 is user friendly and includes, for example, a series of pull down menus, forms and selectable items.

The editor supports a variety of edit functions including, for example, typing, formatting (e.g., bold, italic) and clipboard operations (e.g., cut, replica, paste), and operations that respond to keyboard and mouse events, operations performed via a toolbar, and operations performed via a mouse click. The editor determines where an edit occurred and also determines the properties of the edit (e.g., color, font, format, etc.) It also supports opening and saving of files that include both formatted and non-formatted text. The editor may further include a speech recognition feature. The editor reads the file provided to it, and converts it to a Switch Notes-specific format. This format can be converted back to the original format on saving the file in Switch Notes. For example, in the text-only version of the present invention, RTF (Rich Text Format) is used. The original file is converted to RTF and then shared among the users of the session. Accordingly in the text-only version, RTF specifications are used to handle the data. In other versions of Switch Notes, formats such as but not limited to JPEG, XLS, etc. can be used. The editor opens text files in a rich text file format (RTF) such that the location of each character of a file is uniquely identifiable. Thus, whenever an edit command is received, the system performs the edit on the replica of the file on which the edit is made and then makes the same change in the same location on all corresponding replicas. Similarly, in a spreadsheet implementation, each cell of a file is marked according to a unique identifier corresponding to a cell address and for a graphic file, lines of marking uniquely identify screen coordinates of the file. The cascading process receives an edit from a marked place of a file and sends the edit to the same marked place of a replica of the file.

Because the editor works according to the type and location of an edit, it is language independent. Therefore, the editor can handle fonts of any language that a user has installed on his or her computer. The editor also allows each of the session participants to edit local files (i.e., files other than the shared replicas) during a session. For example, if one participant has edit control, while that participant is editing a replica of a file, the other participant may be working locally on a file that is stored on the hard drive.

Server 115 also includes the conventional components of a computer including memory, at least one processor, storage, and input and output devices. The memory of server 115 further includes a VMS tool 130, which allows multiple users to access files simultaneously. The tool 130 coordinates interaction among users via the interface 125. Files that may be simultaneously accessed by the multiple users are uploaded from a user's local storage 140 on a client 105 or 110 to server 115 for virtual storage as file 150. The VMS tool 130 is not language or application dependent. It is operable with any application included on clients 105 and 110.

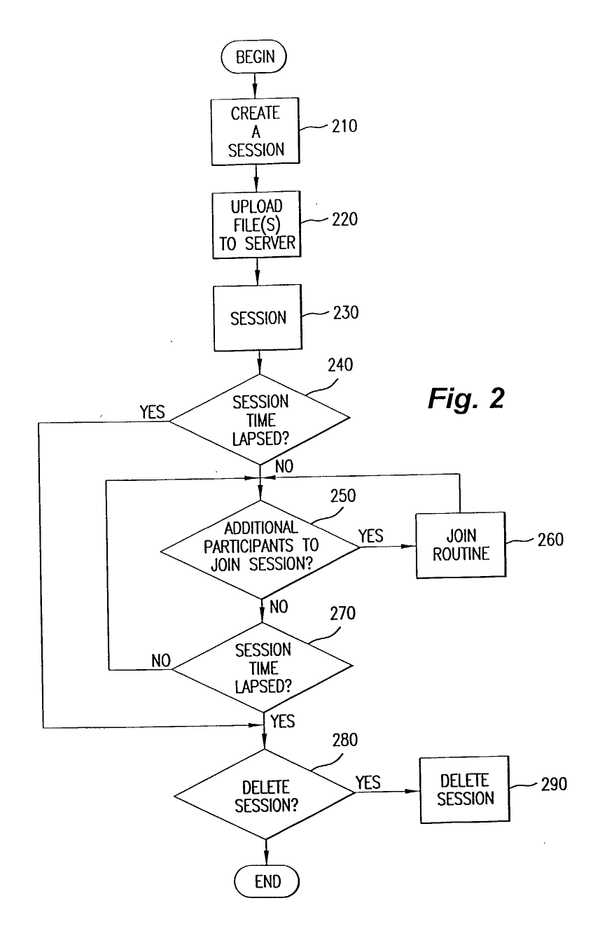

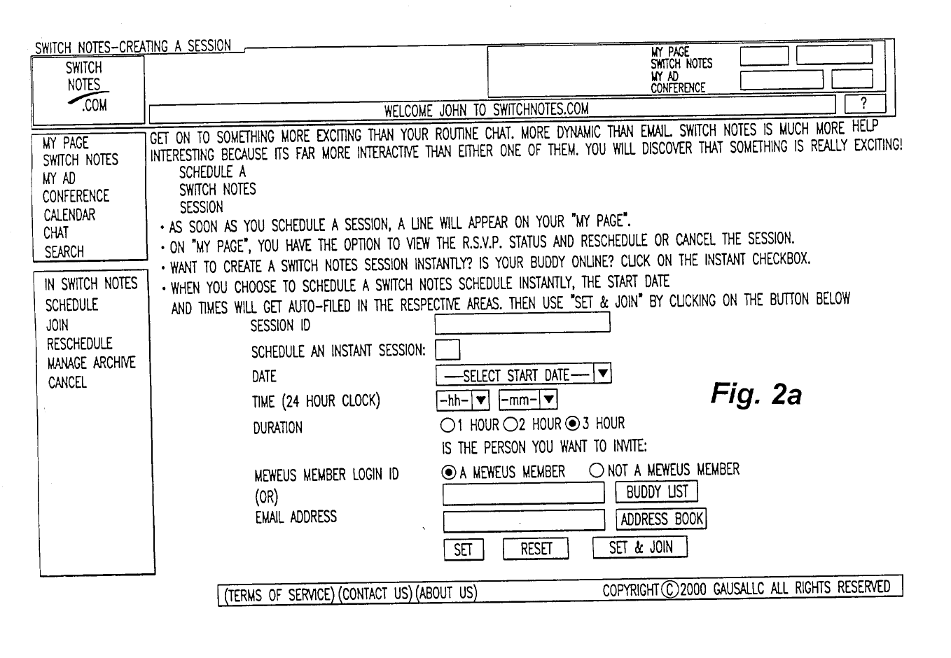

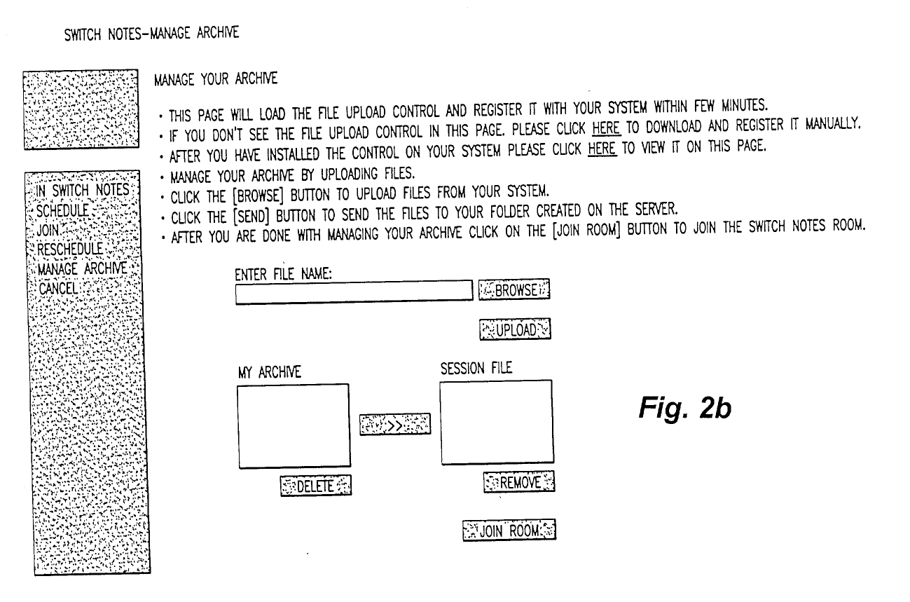

FIG. 2 depicts an exemplary flow diagram of the operation of a virtual meeting space tool in accordance with the present invention. An initiating user begins by creating (i.e., scheduling) a session 210. In other words, the user who creates a session is also the initiating user of the session. FIG. 2a depicts an exemplary screen shot of a form that can be used to create a session. A session is identified according to a unique identifier and includes a begin time and an end time. The session may therefore be represented, for example, by an application level array that includes a title, a description, one or more invitees, an initiating user, and a session application number. When creating a session, a system user provides the necessary information via the system interface. The creator of a session indicates each of the desired session participants because only indicated participants will later be allowed to join the session. The creator of a session can amend the list of invitees to reflect additional participants at any time between creation and deletion of the session. After a session is created, the system notifies each of the invitees of the session, for example, by sending an instant message to each of the invitees, informing them of information about the session, including its name, initiating user and time of operation.

In this embodiment, to begin a session a session participant uploads one or more files to a server at step 220. FIG. 2b depicts an exemplary screen shot of a page that can be used to upload a file from a participant's local drive to a server. The VMS tool 125 on each user's computer performs this upload function. The files that are uploaded to the interface can be accessed by any of the participants of a particular session. Once a file has been uploaded, it is treated as a virtual file in that a replica of the file resides on the server until its originator opens it. This approach of basically for archiving files on the server before a session has to start. If needed, the user can also provide a file directly from the hard drive of his or her computer. When a file is opened, a replica of the file is downloaded to a memory area of each of the session participants' machines. It should be noted at this juncture that session participants might upload additional files to the server as desired throughout the session. Additionally, session participants may create new files or download files retrieved from an Internet browsing session and upload the files to the server. Other session participants may view all such files when the originator opens the files.

Once an uploaded file (which resides at the server 115 in this embodiment) has been opened, a replica of the file is downloaded to the local interface of each of the session participants. As described above, each of the session participants has full access to shared files (on receiving the switch, i.e., the control of file), including editing, saving, merging and printing capabilities throughout the session at step 230. As described above, during a session, changes made by each participant are automatically cascaded to other session participants. A single session participant has editing control of all session files at a given time during the session. The session participant in control can save, edit, merge, or print a file. When a session time lapses (e.g., as determined at steps 240 and 270), the session may be closed or extended. Prior to closing a session, the system provides each participant an opportunity to save the replica of the file.

Additional participants may join a session at any time, such as at steps 250 and 260. A user may join a session by providing an appropriate input to the system, for example, by selecting an icon on the system interface. Only users who are listed as invitees to a session may join a session. Therefore, if a user attempts to join a session and the user is not indicated as an invitee to the session, the system 100 denies the user access to the session. Each time a new user joins a session, the system 100 automatically reformats the display of all participants to reflect the newly joined participant. An invited user may join a session at any time during the duration of the session.

After the session time has lapsed, as indicated above, the session automatically terminates at step 270. While a session can be deleted by its creator at any time after the session has been created, this exemplary flow diagram illustrates a session deletion as occurring after the session has been terminated at step 280. To delete a session (e.g., at step 290), the session initiating user selects an indicated session from a list of sessions and deletes it. When a session is deleted, all files associated with this session that are stored on the server archive are also deleted. Receiving and processing the information relative to creating, joining and deleting sessions is well known in the art and is, therefore, not described in further detail herein.

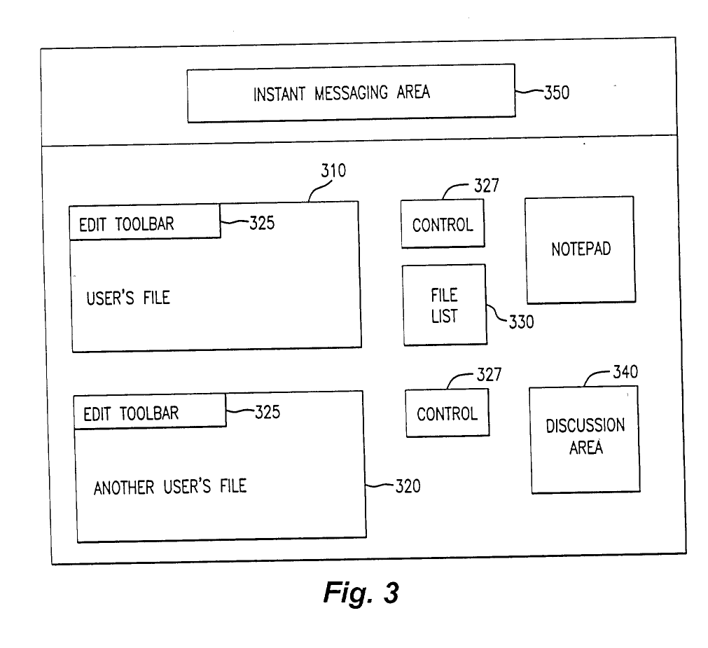

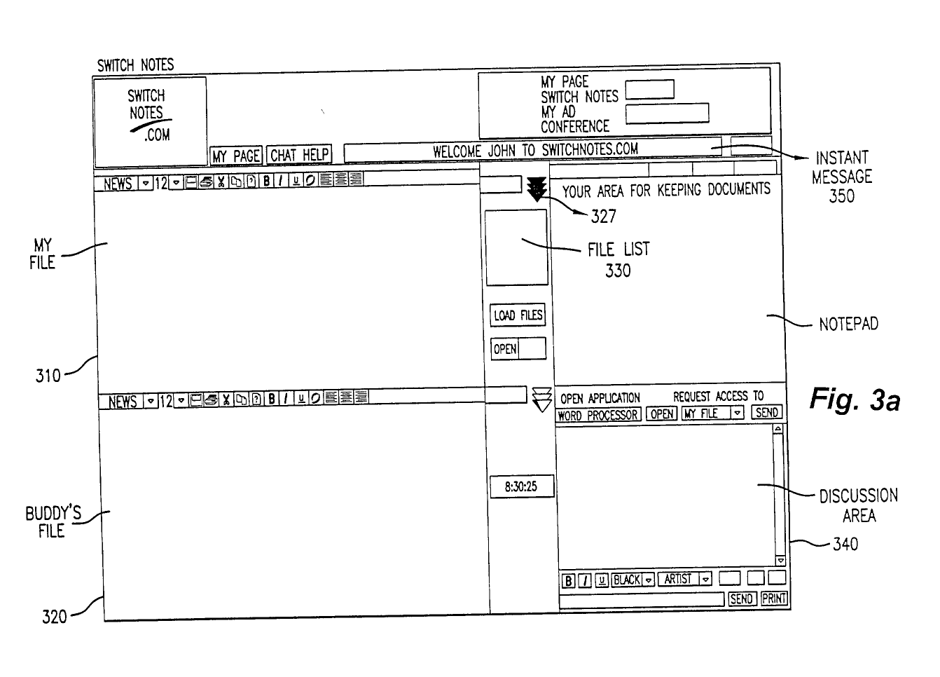

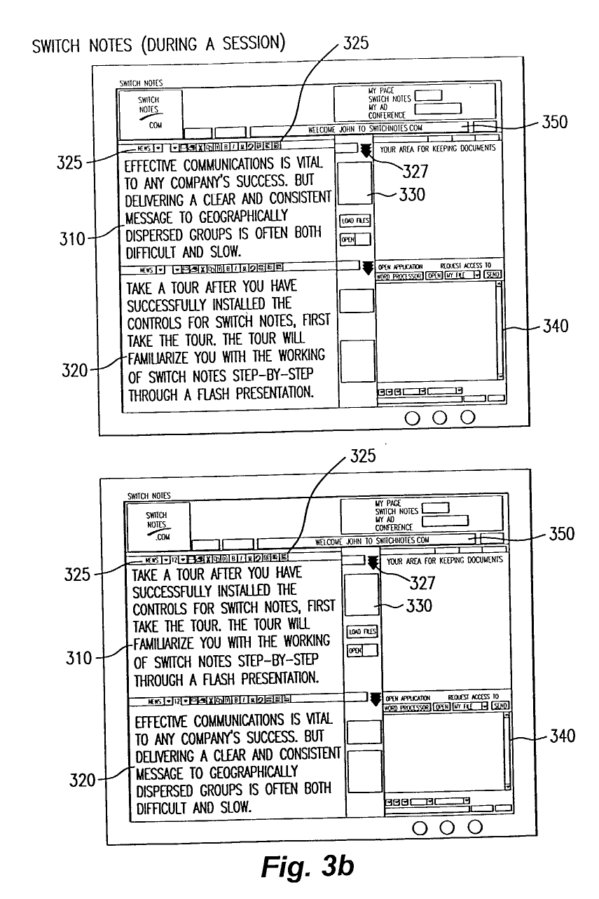

FIG. 3 depicts an exemplary screen layout of a virtual meeting space tool interface in a two-user implementation in accordance with the present invention. FIG. 3a depicts an exemplary screen shot of the screen layout depicted in FIG. 3. As depicted, the interface simultaneously displays both the current user's file and another user's files, 310 and 320, respectively. Each of the session participants can edit any of the open files in the session according to the editing functions provider on edit tool bar 325. Each session participant can open a single file at a time, although each session participant can open multiple files during a session. The participant that has edit control at a particular point in time can edit files. Control indicators 327 correspond, for example, to selectable buttons that both indicate which participant has control and provides that control to the indicated participant. The participant having control is the only session participant who possesses complete file editing capabilities, subject to any restrictions that the host (creator) of the session might have imposed for the current user. Thus, each of the control indicators 327 indicates whether a particular participant can perform edits or not. For example, the control indicators 327 may be of different colors such that a green indicator 327 indicates that the user 310 can perform editing operations on all session files and a red indicator 327 indicates that the user 320 only has read access rights to all of the open session files. The edit functions of all participants not having control are effectively locked such that the participants have read only access to the open files. Read only file access includes scrolling operations.

Edit tool bar 325 includes basic editing operations including, for example, clipboard operations such as cut, paste and copy, drawing functions, formatting, etc. The editor also includes a function that records editing operations performed by the user. This function therefore supports undo, redo, and track change editing operations. Each time an edit is performed, the edit data is cascaded over the network and transmitted to each of the files included on a computer that is participating in the session. To appropriately cascade data edits, the system determines the following information: (1) the edit; (2) the type of the edit (e.g., type formatting, a clipboard operation, etc.); and (3) where in the file the edit occurred. The virtual meeting space utility compresses and encrypts the cascaded data to ensure that it is sent according to an optimal transmission rate. Conventional compression and encryption techniques are used to compress and encrypt the data.

When transmitting data across the network among computers, the system ensures that the data is consistent and that lost data is tracked and restored. The system uses a sequential data checking mechanism in which each data packet sent from one node to another is sequentially numbered. Any discrepancy in the order of received packets indicates a data loss. When a data loss is detected, a data restoration mechanism is used to retrieve the lost data from the originating machine. In this embodiment, when a data loss is detected, the control indicators 327 are turned to yellow to indicate such data loss. During this time, none of the session participants can edit a file. When the data loss has been corrected (i.e., when the data restoration is complete), the control indicators 327 are returned to their previous color and edit control is returned to the previously indicated participant. Those of ordinary skill in the art will appreciate that there are different means of indicating data loss, such as, for example, a speech prompt.

Screen area 330 provides an area where a user can list all of the files that have been uploaded to the server. Each session participant can upload multiple files to the server. Once a file is opened, it is downloaded from the server to the local machine of each of the session participants. Edits to the file are thus made on a local replica of the file. As edits are made to a replica of the file, the edits are automatically cascaded to all other replicas of the file. Each time a new file is opened, the current file is closed. Prior to closing a current file, the system allows the participant in control to save the file. The participant in control can provide such control to other participants so that they may save the file as well. Screen area 340 corresponds to a discussion area, where participants can engage in a real-time chat session, transmitting text among each other. For example, the screen layout could conform to a side-by-side arrangement of 310 and 320, and 330 and 340, respectively.

FIG. 3b depicts an exemplary screen shot of the screen displays of both participants of a two-participant session. In the example, the display screens of the two participants are swapped such that screen areas 310 and 320 are reversed on the screens of the users (i.e., the top portion of each user's display screen) includes the user's file. Whichever participant has edit control, however, can edit both files included in screen areas 310 and 320 via edit toolbar 325. Each participant has a different list 330 of files that were uploaded to the server, and each user's display includes control indicators 327, a discussion area 340, and an instant messaging area 350.

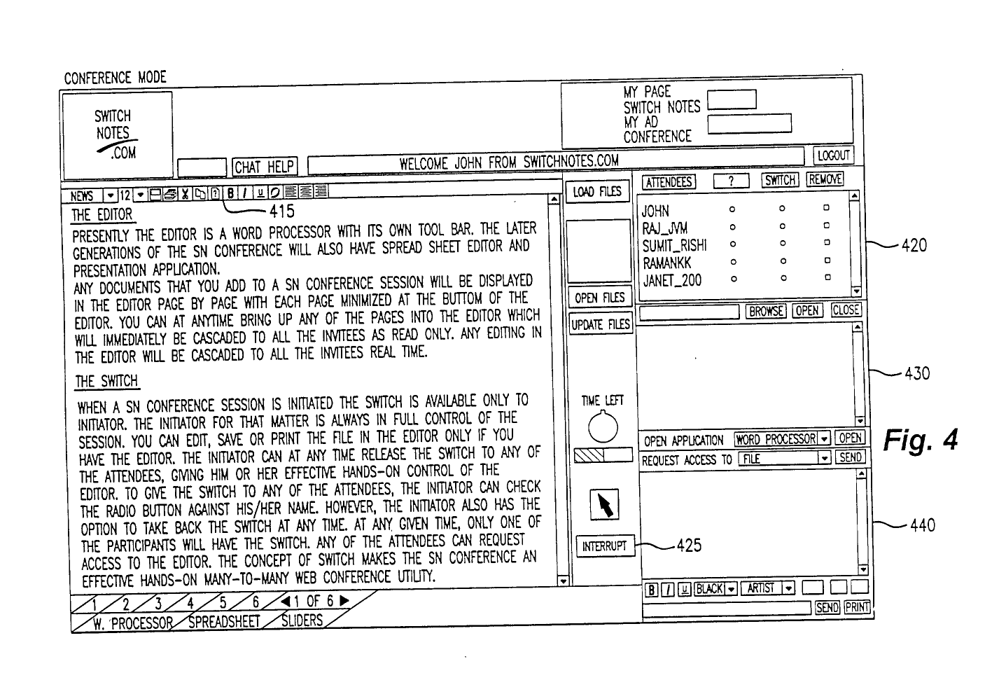

FIG. 4 depicts an exemplary screen shot of a multi-user interface. A multi-user interface may be: (1) the same format of the two user interface described above, where user may open a file, which can be accessed by all other participants. In this implementation, the interface would include the same screen components, although each of the screen areas would be of a smaller size; or (2) a single file that has been made accessible to multiple session participants. In this implementation, as described above, a single participant has edit control at a given point in time and such control can be easily transferred to another participant. Additionally, each participant has a replica of the file, to which any edits made to another replica of the file are automatically cascaded.

In the exemplary interface depicted in FIG. 4, a single file is displayed. The screen of each participant in the session depicted in FIG. 4 would closely resemble the exemplary display that is shown. The file is displayed on the left-hand side of the interface. An edit toolbar 415 is included at the top of the file display area. Multiple invitees, listed at 420, can access the file. For each invitee, the system indicates the following: status, switch, and selection. The status area indicates whether the invitee is participating in the session. The switch area indicates which user has edit control at a given time. The participant having edit control can transfer such control to another session participant by selecting, for example, interrupt 425. The remove area allows a session participant to indicate to other participants that he or she is leaving the session. Areas 430 and 440 correspond to additional areas where a session participant can browse, open and send additional files, and chat with other session participants. Those of ordinary skill in the art will appreciate that these screen shots are for illustrative purposes, and that an actual screen may include additional or different features.

Further details of the virtual meeting space tool are provided below. The following description also explains implementation details of certain novel aspects of the invention. In the following description, the term “buddy” refers to an invitee, “Switch Notes” refers to the system 100 according to the present invention, and “switch” refers to transferring control among session participants.

Switch Notes is a unique concept and product and a new and novel application which allows users at different locations in the world to edit any document over the Internet as well as any other public or private network. The edits made by the user on a document are caused to happen in all of the other replicas of documents opened in a session at different locations almost instantaneously by the Switch Notes application. The system is unique both at usage interface level as well as the technical level. At the usage level, its uniqueness comes from the presence of utilities such as the cascading editor, its editing, comparing and merging abilities over the Internet, the switch, chat area, the reference area, and the instant messenger—all present in the same, simple interface.

At an internal level, it is also an effective combination of various technical modules some of which are novel. The uniqueness of this system 100 lies in the following important technical modules that one would have to incorporate in order to develop such an application.

1. Editor. The first and the most basic need is to develop an editor that will provide with basic editing operations. Switch Notes has a root editor that provides the basic editing operations to a user on a stand-alone basis.

2. Recording an Edit. The next important phase is to build the capability to record the editing operations done by the user. This had to be done in a way that all possible editing operations are recorded within Switch Notes.

3. Cascading of Edits. This is the most crucial part where the edits are to be cascaded. Under this section, the following points are important:

a. To be able to cascade data over the Internet or any other public or private network to any computer that has an access to the Internet or any other public or private network as the case may be.

b. To make sure that the data cascading happens with the most optimized time rate. For this, an appropriate level of compression is necessary.

c. To make sure that the data that is being cascaded is secure through the transfer channel. For this, an appropriate level of encryption mechanism needs to be adopted.

d. To make sure that the data is cascaded at the right place as in the master document. For this, one needs to identify, for example: (1) What is the edit? (2) What is the Edit Type? and (3) Where is the edit? By “edit type”, the system 100 determines whether it is a typing, or formatting or a clipboard operation (e.g., cut/copy/paste). By gathering all of this information, the process of cascading the edit to the destination editor becomes relatively easy.

4. Data Consistency. It is very important to make sure that the data traveling between nodes is consistent and that no loss is happening on the way. For this, a sequential data checking mechanism was needed. Each data packet sent from one node to another is numbered. Any discrepancy in the order of received numbers indicates a data loss, in such a case, a restoration mechanism tries to retrieve the data again from the originating end.

5. The Switch. This is done to make sure that the switch transfer happens for the appropriate destination editor of the buddy online. Also, it is done to make sure that a green/red combination (i.e., edit/non edit) is always maintained during usage.

6. Locking of Editor. This is done to make sure that the locked editor does not accept any editing operations from the user; but, at the same time, to allow the readability and scrolling features on this editor.

7. The Browse Area. Switch Notes allows for opening a reference document that will not be shown to the buddy at all. In the Browse Area, the user can open any document from his or her own computer and use it as a reference document for the online discussion ongoing in the Switch Notes editors. The user can do comparison/merging of the documents open in the Switch Notes editor and with this stand-alone reference document.

The building of an editor that tells the system what has happened is the first part of the process in developing the system 100 according to the present invention. The following are the key requirements of this editor:

1. It should allow typing;

2. It should allow formatting operations (e.g., bold/italic etc.);

3. It should allow clipboard operations (e.g., cut/copy/paste etc.);

4. It should allow operations that respond to keyboard and mouse events;

5. It should allow operations through a toolbar;

6. It should allow operations through a right click menu of mouse;

7. It should tell the system where the edit happened;

8. It should tell the system what are the properties of the new edit happened (i.e., color/font/format etc.);

9. It should allow opening and saving of documents that contain formatted as well as non-formatted text; and

10. It should allow speech recognition.

The above and other objects are achieved in the following manner. Being an editor control, it automatically allows typing. Such operations can either be invoked through toolbar/keyboard/right click. The key thing is to identify the property that would make this happen. For this purpose, one makes use of properties such as SelBold, SelItalic, SelUnderline, etc. available in the Edit Control. The behavior of these properties would vary with changing their value from FALSE (default) to TRUE.

Clipboard operations through the keyboard (e.g., Ctrl C, ctrl X, ctrl V) are by default supported by this control. But, to handle such as icons through the toolbar and right click menu, one makes use of the Clipboard object. The system used the methods SetText and GetText of Clipboard object to perform the clipboard operations as needed.

Being a basic editor control, it does respond to keyboard and mouse events. For this, one has to make an image list control with a number of pictures acting as buttons in it that would further correspond to the desired action. For this, the right click of the mouse is tripped in the mouse down event, and then invoking a menu item that further contains the desired sub menus for the required actions.

Edit control has a property called SelStart that tells the system where the edit has happened. The basic assumption here is that the numbering of characters of any document will never vary. In other words, if one has a document that contains a word “switch” at number 10 in the document, then it will remain at the same number till the document is changed. SelFontName, SelFontSize, SelColor, SelBullet, etc expose the properties of the new edit. All of these properties (called Set A) together tell the system about what the new edit looks like.

The EditControl has methods LoadFile and SaveFile that allow opening of an RTF (Rich Text Format) document into the editor. As a pre-process to the Switch Notes session, while uploading the document to the server archive, the document is converted to RTF. This conversion also makes sure that the Switch Notes editor can then allow online editing online of various types of documents.

Edit recording is done in various events of the editor, namely the Keypress, keydown, keyup, mousedown, and mouseup events. The character set of the keyboard is covered through the KeyPress event. The multi-character set of the keyboard is covered by the KeyUp and KeyDown events.

Basically, and edit can be one the following:

1. Typing;

2. Formatting; or

3. Clipboard operations.

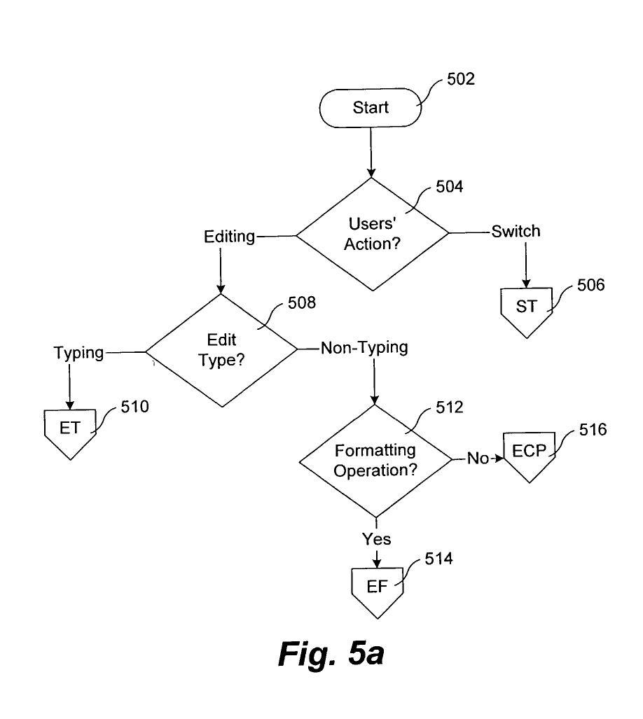

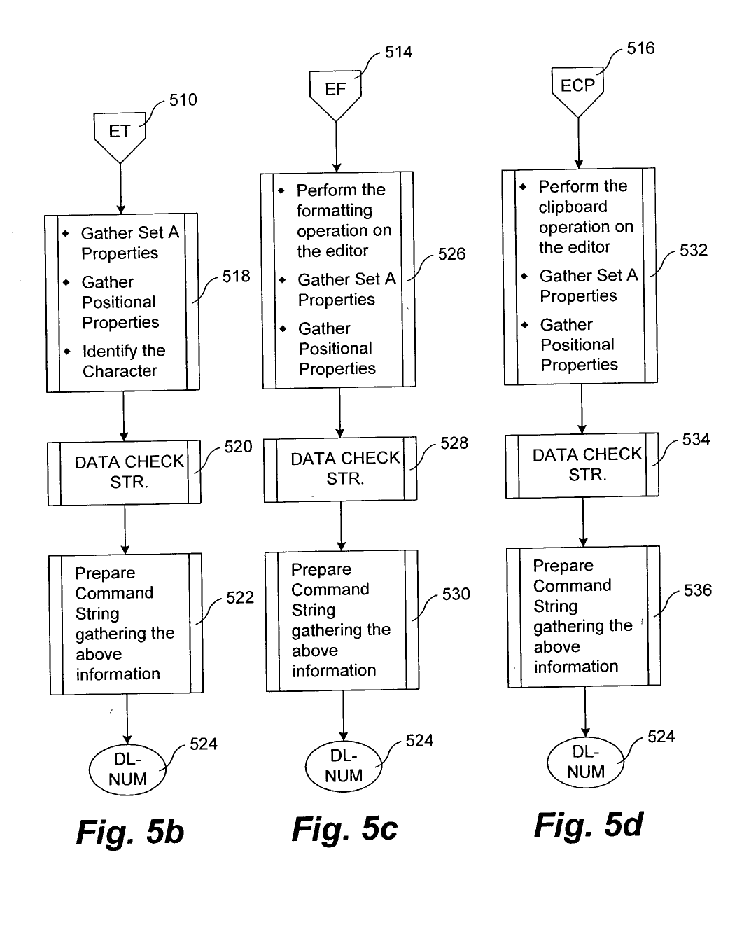

Event handlers written as mentioned above gather all the Set A properties, the positional properties (SelStart, SelLength), and the data of the edit, merge them into a large string of information. This string is known as the Command String. The Command String is the key to the whole system. It carries all of the information needed for the receiving editor to carry out the corresponding cascading operations. FIGS. 5a-5d explain this phenomenon. The flow chart connectors ET (Editor Typing), EF (Editor Formatting), and ECP (Editor Clipboard) handle the preparation of command strings based on user's actions.

The next step is to dispatch the Command String to the destination(s) editor. The Switch Notes control is embedded in a container (i.e., a browser). There is a hidden Java Applet in this container. The ActiveX control and this Java Applet can communicate with each other using JavaScript.

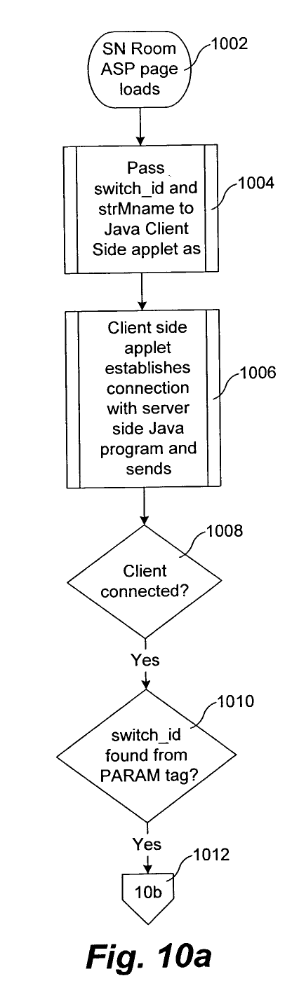

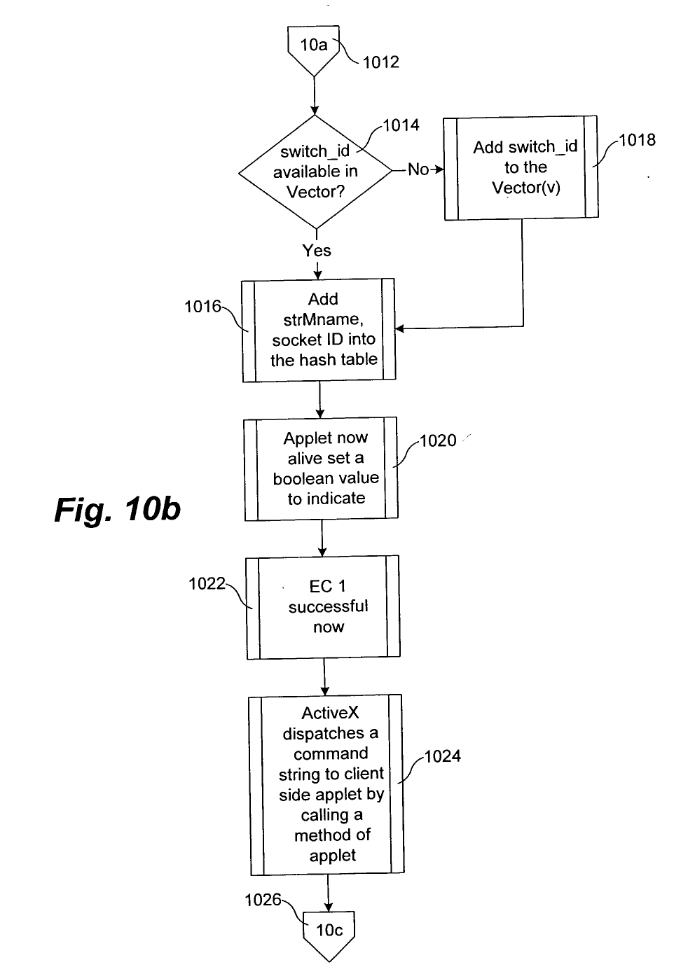

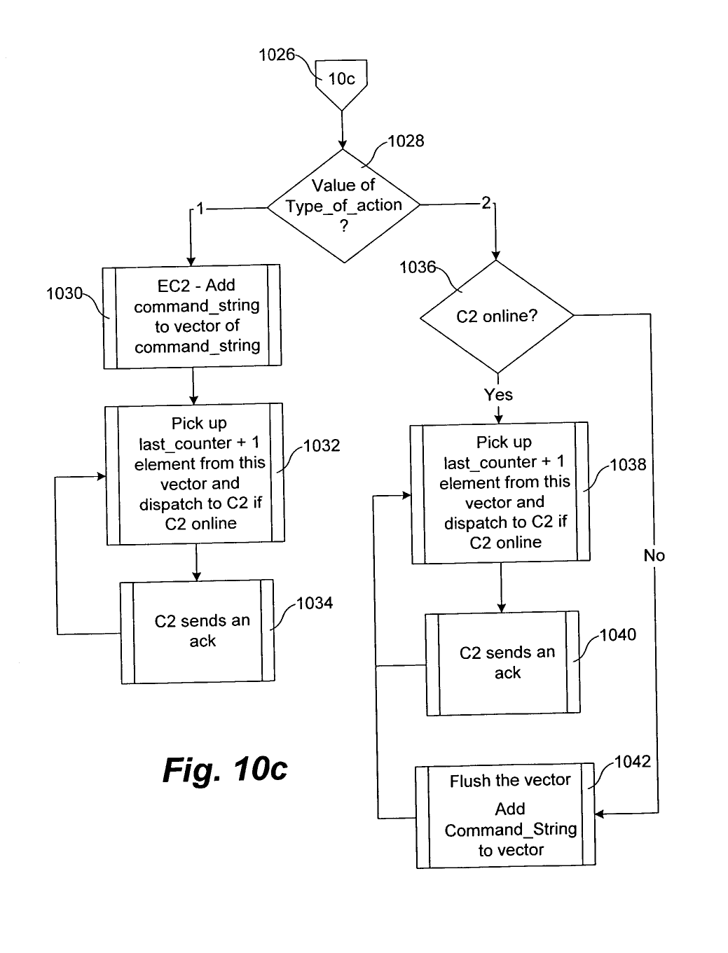

The Command Strings travel through the ActiveX→JavaScript→Applet channel to the Switch Notes server where a Java Server program processes these strings. Internally, each Switch Notes session has a unique ID. Within each Switch ID, there can be user(s). The Java Server identifies the ID of the buddy to whom the data should go from ID of the originating user. If the buddy is connected to the server at this stage, the data is sent to the destination. The Java Socket programming is used in this data transmission. The flow chart connector EC (Editor Communication) in FIGS. 10a-10c describe how Java programs handle the transfer of data.

The Command String to be dispatched to this communication mechanism occasionally will contain the data in large proportions also like some pasted data or some document data. Passing such a big amount of data over the Internet in its base form is never a good idea. Hence, to speed up the process, the data must be compressed. A high degree of compression must be used for such Command Strings. At the receiving end, again, the data is decompressed and presented to the destination editor in base form. Such data must also be encrypted for only Switch Notes to understand it.

At the receiving end, first the Command String is interpreted as to what the string is for. After this, the appropriate execution scheme is triggered. In general, any execution scheme will do the following:

1. Set the positional parameters of the destination Editor to be the same as at the origin (i.e., set the SelStart and SelLength)

2. Set the Set A properties

3. Print the data/Make the corresponding change

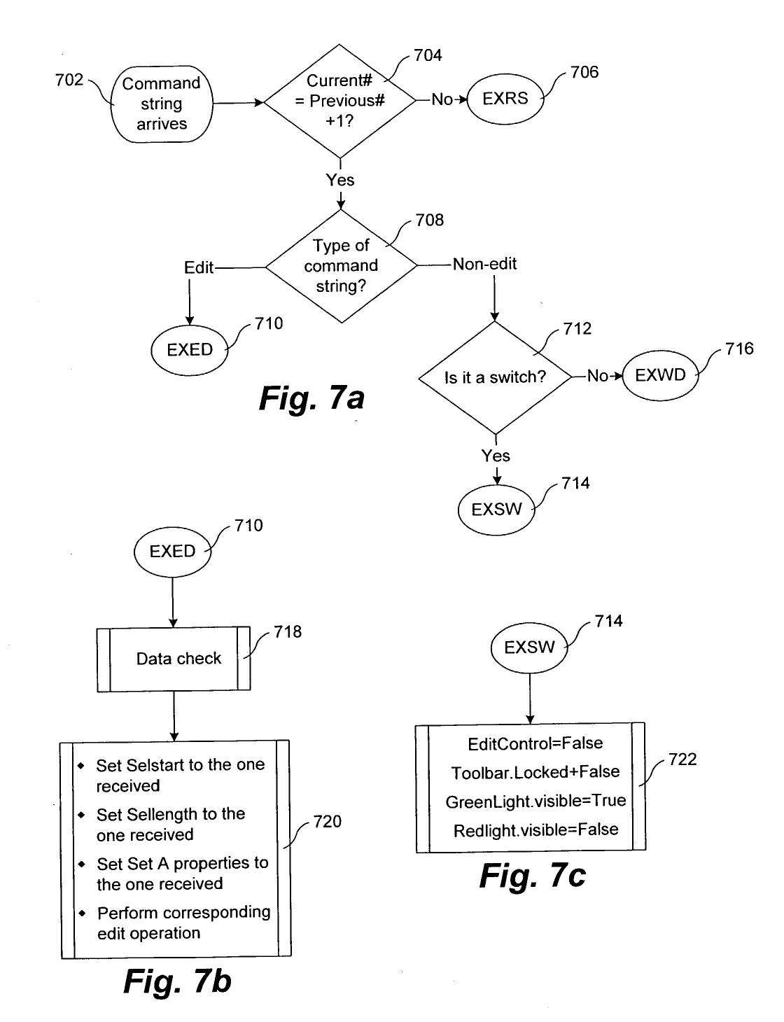

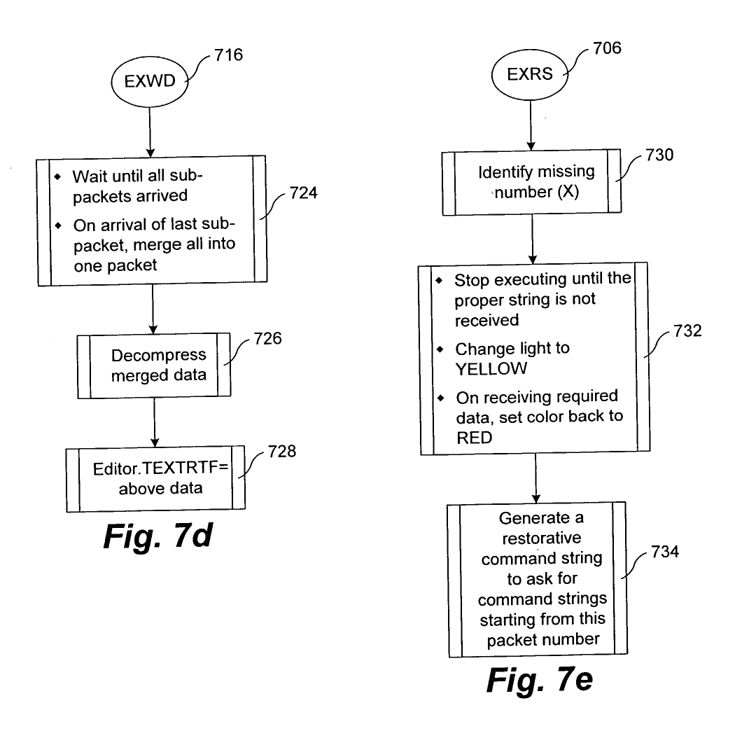

FIGS. 7a-7e explain this execution procedure. The flow chart connectors EXED (Execution for an Edit), EXWD (Execution for Whole Data), and EXSW (Execution for a Switch) handle the execution of the incoming Command String.

One important aspect of Switch Notes is that it can handle any language fonts. If, for example, the users have a font of Russian installed on their computers, then they can do editing online in Russian language. Both the users can continue to edit their own documents independently of the buddy's edits. A similar cascading logic can be implemented for applications like spreadsheets, graphics, CAD, etc. The key factor is to identify what is same in both the documents. In a text-based document, for example, the character numberings remain the same in both documents. On the other hand, in a spreadsheet application, the cell addresses are the same, and in a graphics application, the screen coordinates are the same.

Another problem that is encountered in data transmission process is to make sure that the data packets are sent and received in order of their generation. For this, a numbering mechanism of the data packets must be prepared. Each packet (i.e., Command String) originating from one end to another is sequentially numbered. At the receiving end, the sequence of packets is noted on each receive operation. The instant any discrepancy in numbering is found, it is taken as an error, and a restorative mechanism triggers on to get the missed data back from the originating editor. In such a case, the Switch lights 327 are turned to Yellow to indicate a data loss. At this point, no editing operations are allowed. On the completion of the restorative mechanism, the lights are brought back to the original stage. The flow chart connector DL-NUM in FIG. 9 explains this numbering scheme.

The Switch is the indicator of control. Normally there is always a diagonal relationship of red/green states of the editor. By default, the editor of the Switch holder is with the GREEN light, and others with RED (allowed, but not having switch), OR YELLOW (not allowed in the session or data loss). In order to make sure that no editing is accepted by the editor, the LOCKED property of the EditControl is set to TRUE. In accordance with RED light, the editor's toolbar is also made Locked. Switch transfer is also treated as a Command String. This command string does not carry any user data. It only carries a flag saying TRUE. On receiving of this flag, it is interpreted that a Switch transfer has happened. The Switch Concept can very well be applied to any other application also whereby only one person can take control of the application at one time. Switch transfer would make sure that the Control is shifted to the conceded destination.

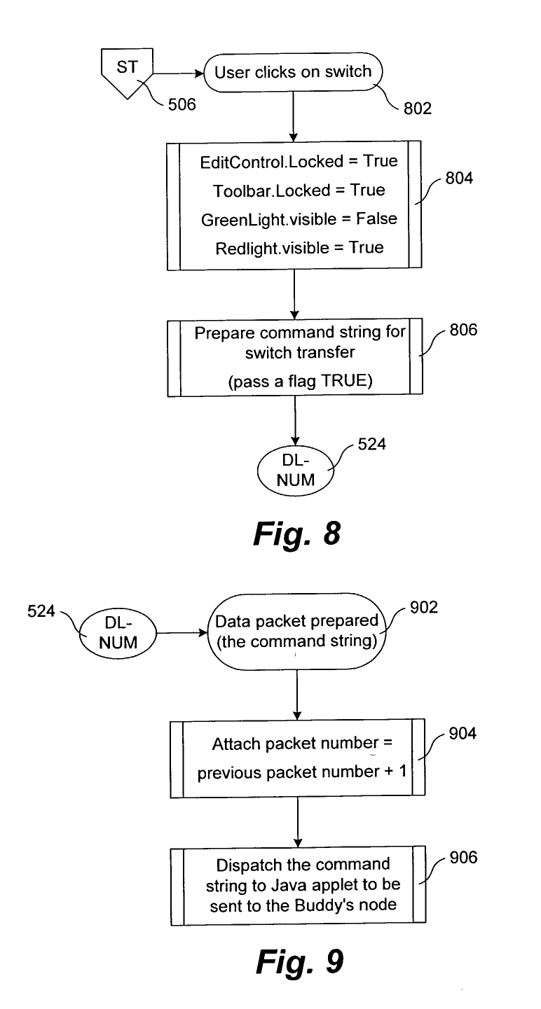

The three lights provided with the Switch act as a visual signal for allowing effective communications. While the green and red lights indicate the user's rights to edit the document, the yellow light works as a status indicator. If there is a data loss encountered by the system, then the light turns YELLOW and remains yellow till the restoration happens. At this point, no editing operations are allowed. If the buddy goes offline, then the lights turn GREEN and YELLOW together indicating that the buddy has gone offline, but the user can still do the edits. IF the light is RED or YELLOW alone, then editing is not allowed, but if the light is GREEN OR GREEN+YELLOW, then the editing is allowed. The flow connector ST (Switch Transfer) in the FIG. 8 explains the switch transfer phenomenon. If the users are waiting to be allowed in the session, then the light color is also YELLOW. If the users have not joined the session at all, then the light color is GREY.

Locking of Editor

For this the locked property of the EditControl is set to TRUE. This ensures that the editor accepts no editing.

Referring again to FIGS. 5a-5d, it can be seen that this module handles the preparation of the Command String based on a user's actions. As mentioned earlier, the editing can only be of three types: typing, formatting, or clipboard operations. To handle each of these three, separate handling procedures must designed. They are presented under the heads ET, EF, ECP. Also, if the user does not any edit operation and clicks on Switch button, then also a Command String is generated (shown as ST in FIG. 5a).

ET (Editor Typing)

In this event as shown in FIG. 5b, the Set A properties (namely, SelStart, SelLength, SelColor, SelFontSize, SelFontName, SelUnderline, SelBold, SelItalic, SelBullet, SelAlignment) are gathered at step 518.

SelStart indicates the current position of the cursor. SelLength indicates the length of text currently selected. SelColor indicates the color code (i.e., a numeric value that is interpreted as a unique color). SelFontSize indicates the font size of the selection of text. SelFontName indicates the font name of the current selection.

SelUnderline is a flag that can be set to TRUE/FALSE. TRUE indicates that the selection of text is underlined. FALSE indicates the opposite. SelBold is also a flag that can be set to TRUE/FALSE. TRUE indicates that the selection of text is bold. FALSE indicates the opposite. SelItalic is, likewise, a flag that can be set to TRUE/FALSE. TRUE indicates that the selection of text is italicized. FALSE indicates the opposite. Finally, SelBullet is a flag that can be set to TRUE/FALSE. TRUE indicates that the selection of text is bulleted. FALSE indicates the opposite.

SelAlignment indicates the Left/Center/Right alignment of the selected text.

Now, if there is no selection, then the SelLength will be ZERO. The system will still get the values of each of these flags. The concept is that the properties at a particular cursor position will always be those of the preceding cursor position unless the user has changed them at the current position (e.g., such actions one is recording, so the system always know the properties of the current cursor position).

Also, if the selection is a mixed one (i.e., if some part is underlined and some is not), then SelUnderline (and such properties) return to NULL. So, the system 100 has to make a check on this before sending them to the buddy's editor for execution.

The character typed comes through the value of KEYASCII obtained as an argument to the event handier KEYPRESS of the editor. The KEYASCII value is a unique number that represents that character. For example the capital letter “A” is equal to 65.

The system traps what character has been typed, and all the Set A properties—giving special importance to the positional properties (i.e., SelStart and SelLength) are merged into the command string. Now, the actual Command String is prepared. It is further sent to the numbering scheme (DL-NUM) for processing.

EF (Editor Formatting)

As shown in FIG. 5c, this type of editing only changes the appearance of the text already present. It does not add or delete any text from the document. The normal way of bringing out such changes in an editor is to select a part of text from the document (e.g., by highlighting), and perform the desired operation. This desired operation can be invoked whether by keyboard commands, such as Ctrl B, Ctrl U, Ctrl I, or by Toolbar icons, or by the Right Click menu option “Font” that launches a font dialog box. In each of these operations, the main properties of importance are the cursor position of the selection start and the length of the selection. SelStart and SelLength obtain these.

Appropriate event handlers are incorporated in the system that identify a formatting operation. The first part in those event handlers is to make that change on the main editor, then to prepare a Command String so that the same operation happens on the buddy's editor. For example, if a bold operation has been performed, then the SelBold property of that selection is just negated (to reverse the effect—i.e., bold becomes non-bold and vice versa). The changes property and the positional parameters are merged here and a Command String is prepared. Then, this Command String is dispatched to the numbering mechanism for processing.

ECP (Editor Clipboard Operations)

As shown in FIG. 5d, such actions deal with the clipboard. Out of these, only Cut and Paste change the document. Copy only takes some text to the computer's memory. Hence, the main actions here to be cascaded were Cut and Paste.

The clipboard actions are to be default handled through the keyboard on any editor—i.e., Ctrl C (copy), Ctrl X (cut), and Ctrl V (paste). However, programming is required to perform such actions through the toolbar icons and Right click menu options. For this, the ClipBoard object is utilized. For copying the text into the memory, the Clear (to clear the memory), and the SetText (to put text into memory) are used. To cut, first the data is put into memory as explained in Copy and then the data is deleted from the document. For paste, the GetText method is used. It returns the text currently stored in the memory. Similar actions need to be reflected at the buddy editor, and not that the similar actions be performed on buddy memory. Hence, simulating actions are prepared for the clipboard actions performed on main editor.

For a Cut, just the SelStart and the SelLength of the text cut is gathered and the Command String is prepared. For Paste action, the SelStart, SelLength, Set A properties and the pasted data (retrieved from the Clipboard.GetText method) is gathered and put into the Command String. In case of the Paste data, this data is also compressed and packetized first and then merged into the command string. After preparing the Command String, it is passed to the numbering scheme.

ST (Switch Transfer)

As shown in FIG. 8, this occurs when the user clicks on the Switch button to transfer the switch of the document in the editor to the buddy's editor. This action triggers the following on within the system:

1. Making editor locked (locked=TRUE).

2. Making toolbar locked (locked=TRUE).

3. Making Red light visible and Green light invisible (visible=TRUE/FALSE).

4. Preparing a Command String that contains a flag TRUE to make it a SwitchCommand String.

As a result of the Switch Transfer action, the user receiving the switch can now make edits to the document based on the rights specified to this user by the host of the session. After the preparation of the Command String, it is sent to the numbering mechanism.

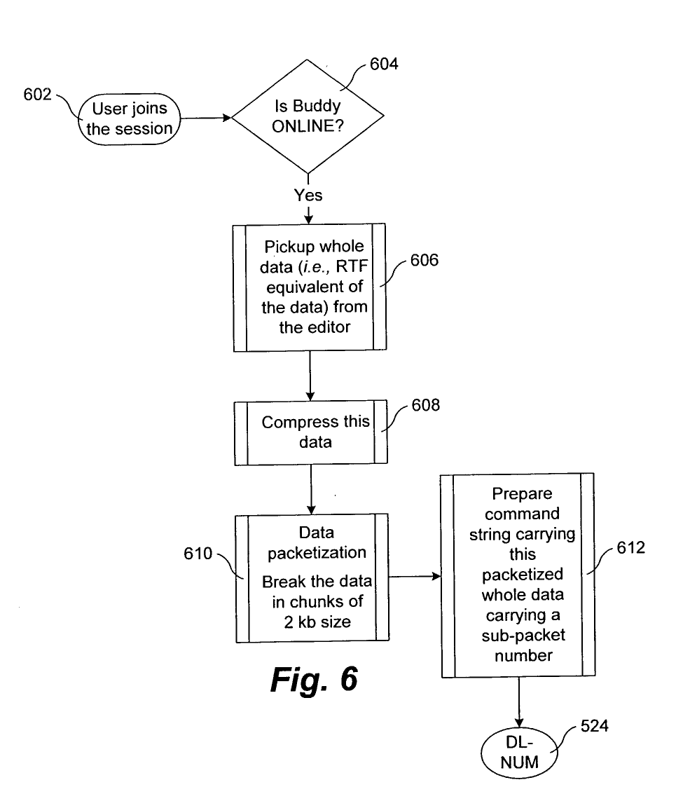

Referring again to FIG. 6, this module handles the processing of editor data when a user joins a session. The basic criteria are that at any point of time, the contents of the diagonal set of editors should remain the same. For this, it must be made sure that when any user joins the session, the complete data present on editor of the user is cascaded to the buddy's editor.

Referring again to FIG. 9, in this module each Command String ready to be sent out from the computer is tagged with a unique number. This number is a running sequence of numbers. This numbering makes sure that at the receiving end, a check can be done for any missing packet. Once the number is tagged onto the Command String, then it is dispatch to the EC.

Editor Communication (EC)

Referring again to FIGS. 10a-10c, this communication is maintained by the intermediate Java programs. The processing of strings generated from end destined to go to the buddy end is explained in this flow chart. Each Switch Notes session has a unique identification (switch_id). Each user also has a unique identification (strMname). Within each Switch_id, the system can have only authenticated users. The Java Server actually maintains a registry of such sessions and the users within them.

It is very important in this application that the data packets reach the end of the buddy who is in session only and not to any one else. For this, the actual physical identification of the buddy's computer on the Internet (also know as the IP address) should be known. This IP address knowledge is extracted from the Java Socket programming model. In this, a client-side and a server-side socket for each client are made. For each socket, there is a socket ID and that in turn is related to the IP address of the user's computer. Hence, the main identifying factor in this model is the socket ID of the computer.

To start the communication process, when the container of the ActiveX control loads (browser), the Client side hidden applet expects the strMname and the switch_id from the page as an input. This is passed into the applet through the PARAM tags (parameters). This set of information is carried to the Java Server. At the Java Server, it is first checked if any other user is already present in the same session. If this is the case, then an entry of this session id will already be present in the Java Server registry. If this is the case, then the buddy's status gets online for the newly entered user. A status information is sent to both the users confirming that both the users have been now connected. This means that now the communication can start between the two. But, if the case is that the user is the first to join the session, then a fresh entity of this session is made in the Java Server registry, and corresponding to his entry, the strMname of this user is also registered as present online. From now on, if the Java Server receives a packet destined to go to the buddy, then it just picks up the socket information of that buddy and sends it to the buddy. It should be noted that, in this flow chart, C1 and C2 stand for the Client 1 and Client 2.

Referring again to FIGS. 7a-7e, it can be seen that this module handles the operations to be performed after the Command String has been received. The first thing to check after receiving the Command String is whether there has been a data loss—i.e. whether any data packet has been lost on the way to the buddy. For this check, a number called previous_executed_string_number is always maintained. The number attached with the newly received Command String (i.e., packet) should be only one more than the previous_executed_string_number. If not, then it clearly indicates that either:

(1) One or more of the data packets have been lost on the way; or

(2) One packet has reached the buddy earlier than the first one.

Both of these cases are unacceptable. Hence, the instant this error is trapped, no further execution can happen on the editor (i.e., receiving editor). At this stage, the light of this editor is turned YELLOW indicating a data loss.

Next comes the data restoration. Asking the originating computer to send the Command Strings starting from this missing number again does this. Until the point this missing number packet is not received, the editor remains in data loss stage. The connector EXRS of the flow, chart (FIG. 7e) explains this restorative mechanism. In case if there is no data loss, then the Command String is forwarded to the execution modules. So, first it is checked as to what is the type of the Command String. It can either be an edit, a switch, or a Whole Data. If it is an Edit, then the procedure EXED handles the Command String. If it is a switch, then the procedure EXSW handles the Command String. If it is whole data, then the procedure EXWD handles the Command String.

EXED (Execution for Edit)

As shown in FIG. 7b, a data check is run (step 718) to ensure that the edit is going to be done at the right place. Under this sub-module, the following operations are carried out at step 720:

1. Set the SelStart to the one received.

2. Set SelLength to the one received.

3. Set the Set A properties to the one received.

4. Perform the corresponding edit operation—either by printing the received data or by removing the pre-existing data.

EXSW (Execution for Switch)

As shown in FIG. 7c, it can be seen that this event is not an edit operation; hence no data check is needed here. The following operations (step 722) are carried out in this sub-module:

1. EditControl.Locked=FALSE

2. Toolbar.Locked=FALSE

3. GreenLight.visible=TRUE

4. Redlight.visible=FALSE

EXWD (Execution for Whole Data)

As shown in FIG. 7d, this event handles the execution of Command String that carries the whole document data. This data will come in a sub-packet form. As a result, it has to first be merged as one packet at the receiving end. The number of sub-packets is mentioned in the very first Command String that carries the information that a Whole Data Command String is on its way. The following are the steps carried out in this sub module.

1. Wait until all sub-packets arrive (step 724).

2. On arrival of last sub-packet, merge all into one packet (step 724).

3. Decompress this merged DATA (step 726).

4. Editor.TEXTRTF=Above Data (i.e., print the whole data into the editor—where TEXTRTF stands for the RTF equivalent of the whole text at step 728).

Specify Rights of Edits

According to another embodiment of the present invention, the system 100 may be adapted to specify the rights of edits. These tools work towards providing the host with more control over the session (i.e., what session participants can see and what they cannot see, what they can do on a document and what they cannot do).

The tools also provide the host (and it should be understood that there may be more than one host) the ability to incorporate following controls for other users in a session.

1. Selective Locking of Data

2. Selective Hiding of Data

3. Selective Hiding of Edits

4. User Specific Edit Areas in the document

5. Track Changes

6. Predefine insert areas

Selective Locking of Data

A data is termed as Locked when: (1) it is visible; (2) it cannot be EDITED at all by any actions (toolbar/keyboard/mouse); and (3) it does not respond to any clipboard actions (e.g., Copy/Cut/Paste). To allow the host to mark full document or parts of the document as LOCKED/UNLOCKED for various participants, the particular data should remain unlocked at master users' end. To allow the host either to: (1) lock/unlock the whole document in FULL from one or more users; or (2) lock/unlock parts of the document from one or more users, the particular data should remain unlocked at host end. If the host saves the document, all data will remain as such.

Selective Hiding of Data

A data is termed as hidden when: (1) it is invisible to a user; or (2) it is locked (as defined above). This allows the host to do the following: (1) hide/unhide the whole document in FULL from one or more users; or (2) hide/unhide parts of the document from one or more users. If the master user saves the document, all data will remain as such.

Selective Hiding of Edits

The “Hiding of Edits” can be defined as either: (1) whatever edits a User does will not be visible at all to the other users; or (2) the edits will be executed at the other users end, but not visible—will remain hidden (as defined above). This allows the host to hide/unhide the EDITS done by a particular user for one or more users—i.e., if the host specifies that the edits done by User1 cannot be seen (i.e., are HIDDEN) by User2, User3, and User4, then whatever edits User1 does wherever in the document, will not be visible to User2, User3, and User4 until the host reverts this RIGHT.

Hiding of Data v. Hiding of Edits

Considering the following scenarios where:

1. The host has hidden para2 of the document from User2, User3, and User4; or

2. The host has not hidden the edits being done by User 1 from User2, User3, and User4 (i.e., User2, User3, and User4 cannot see the edits of User1). So just as per this, if we consider this individually, User2, User3, and User4 should be able to see all edits of User1.

Now, if User1 does some edits in para2, then they will not be visible to User2, User3, and User4 (even when User1 is open to User2, User3, and User4). That is, the hiding of data may supercede over hiding of edits.

User Specific Edit Areas in the Document

The phrase “Specific Area Editing” refers to an area specified within a document where a particular user can EDIT (i.e., a pre-designated writing space for a user. This function allows the host to specify the following:

1. To designate areas within the document in which one or more pre-decided users could EDIT;

2. There can be multiple Edit Areas specified for the same user in the same document;

3. The particular user may or not be allowed to EDIT in the residue of the document depending on the RIGHTS issued as per Selective Locking and Selective Hiding modules;

4. This module is to be provided on ARCHIVED (a document that has been put in the Server archives) documents as well as SESSION (a document that is being currently discussed upon in Switch Notes Conference/1-1 mode) documents;

5. In case of ARCHIVED documents, users will provide their part of edits/data before the session and at the time host tries to view the document, all those edits of all such users to be merged and shown as one single document;

6. In case of SESSION documents, users to do the edits in sequential manner (i.e., depending upon the order of priority assigned by the host) or to do the edits at the same time in a separate EDITOR (i.e., in this case, the edits of those users to be merged by host explicitly).

Rules of Combined Usage of These Modules:

A SPECIFIC AREA of EDIT can be remarked as LOCKED/HIDDEN for the same user for which the AREA was marked as designated to edit. Track Changes can be enabled in such a SPECIFIC AREA of EDITS. The host cannot UNLOCK data for a particular user for whom that data has been marked as HIDDEN earlier. The host has no need to LOCK data for a particular user for whom that data has been marked as HIDDEN earlier. In a nutshell, hidden right supercedes locking rights. If the host marks a pre-locked data (for a particular user) as HIDDEN (for the same user), then the LOCKED property of that data will be set to NULL (i.e., it will no longer be shown as LOCKED, now it will be shown as HIDDEN). The host might also set different edit rights for the same user for the same document for two different sessions.

USER Interface—Selective Locking and Selective Hiding of DATA and EDITS

The Specify Rights of Edit Module is represented by one of the tabs on the right hand side of the Control Panel. The caption of this tab reads as “Specify Rights of Edits”. This tab will only be available to the host.

The Specify Right of Edits Module can also be invoked while scheduling a Switch Notes Session, or anytime before start of Session through the interfaces provided by the SCHEDULING CYCLE (SC). In that case, the name of the document will be asked for before launching this module. The various interface elements of this part of module will be provided herein below. This option of pre-specifying edit rights will only be available to the host. This tab will remain disabled for all other users.

The following buttons are provided through which various sub-modules of this module can be invoked:

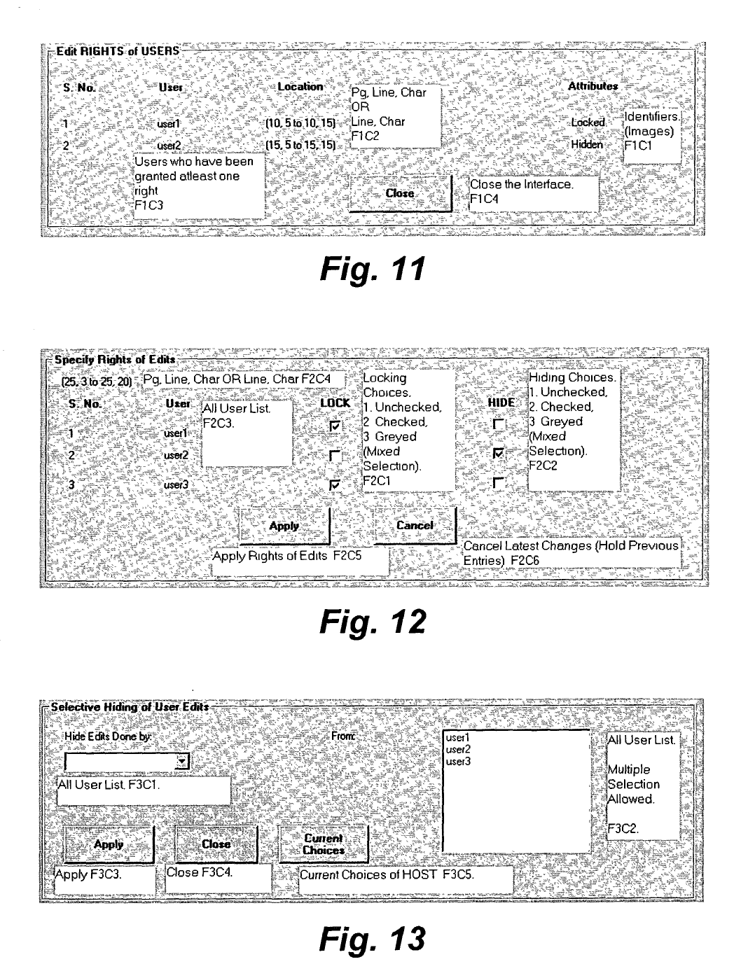

1. See Edit Rights (this button will invoke the interface F1 shown in FIG. 11);

2. Give Edit Rights (this button will invoke the interface F2 shown in FIG. 12);

3. Selective Hiding (this button will invoke the interface F3 shown in FIG. 13);

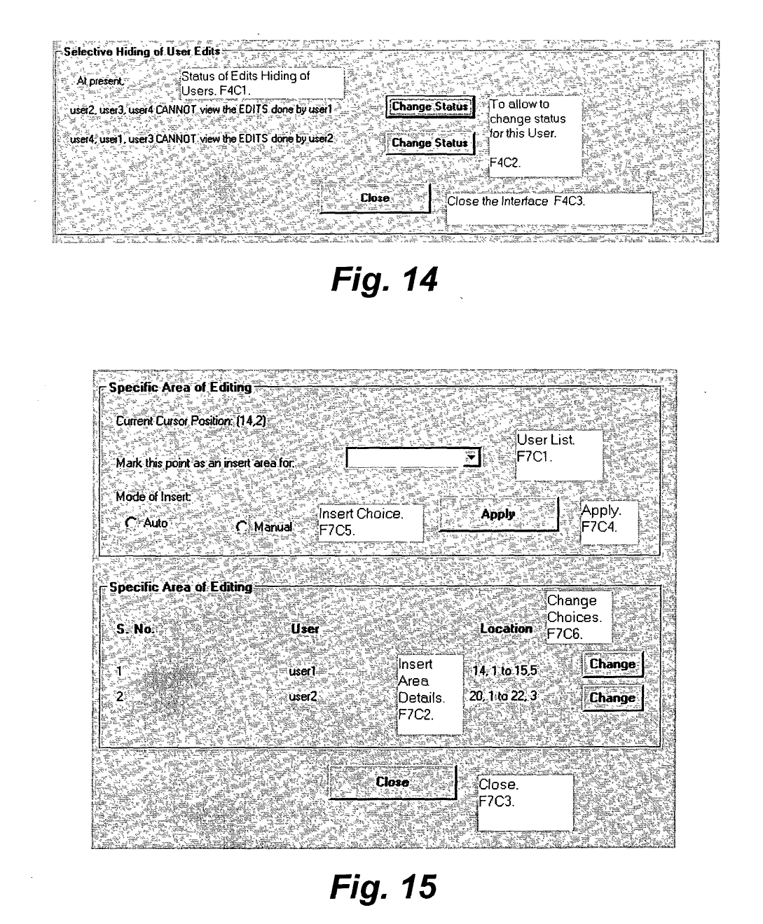

4. Hide Edit Status (this button will invoke the interface F4 shown in FIG. 14); and

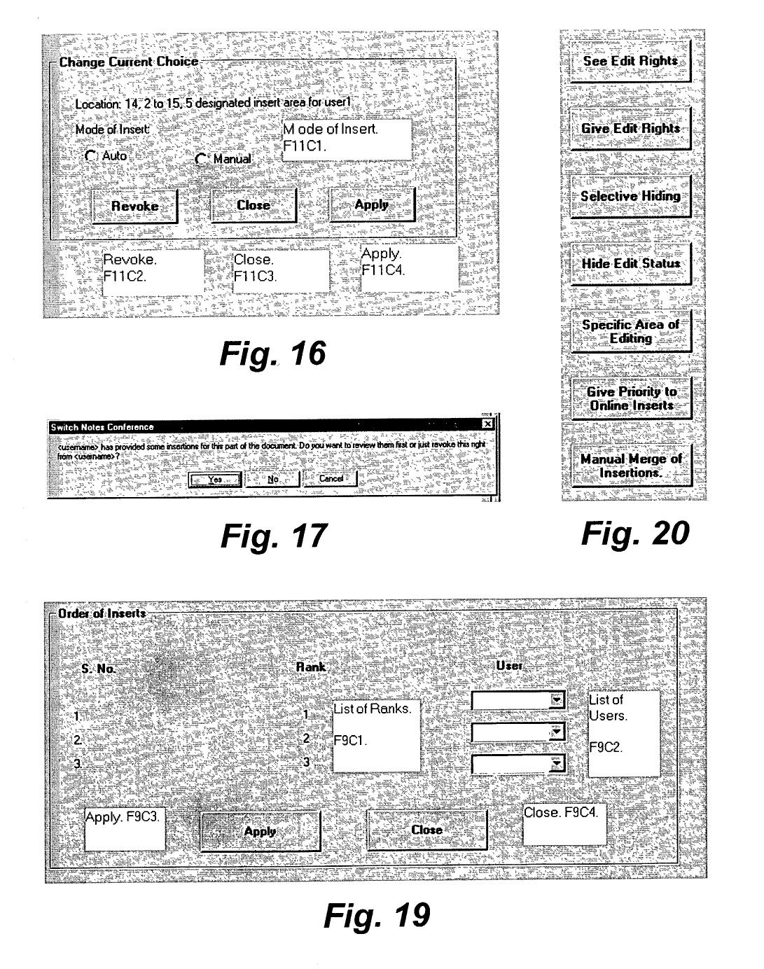

5. Specific Area of Editing (this button will invoke the interface F7 shown in FIG. 15).

It should be noted that the data appearing in the various interfaces shown in FIGS. 11-15 with white background is only for reference.

Interface F1 (FIG. 11)

This interface depicts the current status of various Locked and Hide rights specified by the host for various users of the current document, and comprises the following interface elements (or “controls”):

1. Identifiers (Images) (F1C1): This is a visual indicator that depicts whether the current status of the location for the particular user is LOCKED or HIDDEN.

2. Location (F1C2): This depicts the location of the affected area of the document.

3. Affected User List (F1C3): This is a list of all users (which can be repetitive) that have been affected using the Specify Rights Module. The list will be sorted as per user IDs. All occurrences of the same user will come together. This shows all locations of the document where edits rights have been specified for this user.

4. Close (F1C4): This button click will close this interface.

Interface F2 (FIG. 12)

This interface lets the host specify the rights with respect to selective locking and hiding of data of the current document. The host will have to do the following to reach this interface: (1) select a part of document; and (2) invoke interface F2 from the buttons provided on the Specify Edit Rights tab of the Control Panel.

In order to also allow for full doc lock or hide, this interface comprises the following interface elements (or controls):

1. Current Selection Location (F2C4): This depicts the location of current selection in the document.

2. All Users List (excluding host) (F2C3): This shows the list of all users of the current Session (online or offline both).

3. Lock Choices (F2C1): This is a checkbox that can let the host specify the locking choice for the current selection. There can be three states of this checkbox:

a. Checked: The current selection has already been specified as LOCKED by the host earlier for this user.

b. Unchecked: The current selection has is free of lock rights.

c. Greyed: The host has selected some data in which some part had been specified as LOCKED earlier by host. This is also known as the Mixed Selection case.

4. Hide Choices (F2C2): This is a checkbox that can let the host specify the hiding choice for the current selection. There can be three states of this checkbox:

a. Checked: The current selection has already been specified as HIDDEN by the host earlier for this user.

b. Unchecked: The current selection has is free of hide rights.

c. Greyed: The host has selected some data in which some part had been specified as HIDDEN earlier by host. This is also known as the Mixed Selection case.

5. Apply (F2C5): Clicking this button will apply the choices laid down by the host in interface F2.

6. Cancel (F2C6): Clicking this button will neglect any choices mentioned by the host in interface F2. AND will also close the interface F2.

Interface F3 (FIG. 13)

This interface lets the host specify the list of users who cannot view the edits done by a particular user, and comprises the following interface elements (or controls):

1. All User List (F3C1): This shows the list of all users of the session (including host).

2. All User List 2 (F3C2): This is a multi-select List box that will contain all usernames. The name of the user chosen in F3C1 cannot be chosen in F3C2. For this, the list F3C2 will be auto-refreshed every time a new selection is done in F3C1 to remove the name of the selected user from F3C2.

3. Apply (F3C3): Clicking this button will apply the hide-edit choices for the current user chosen.

4. Close (F3C4): Clicking this button will close the interface F3.

5. Current Choices (F3C5): Clicking this button will invoke the interface F4.

Interface F4 (FIG. 14)

This interface shows the current choices of the host with respect to the hiding of edits of particular user from set of users. It comprises the following interface elements (or controls):

1. Affected User list (F4C1): This depicts the current hide status of each user in a descriptive manner.

2. Change Status (F4C2): This lets the host to reset the edit hiding choices for the user of current row (i.e., the user of current row is the user whose edits have been shown hidden from other users). This invokes interface F3 with the interface elements F3C1 and F3C2 auto-filled from the current row of F4.

3. Close (F4C3): Clicking this button will close this interface.

Scheduling Cycle (SC) Interface Elements

These elements will appear during the scheduling of a Session or during anytime before the start of Session (through the maintain archive page). In addition to all the other elements that have been laid down earlier in previous developments for the scheduling cycle, some new elements have been introduced in this structure. This will be the whole conference interface with no online editing features.

Interface F7 (FIG. 15)

This interface lets the host specify the specific areas for insertions to be done by various users. It comprises the following interface elements (or controls):

1. User List (F7C1): List of all users. The host first points the cursor where he or she wants to create the INSERT AREA for a user. Then, the host chooses the username from this list.

2. Apply (F7C4): Clicking this button will apply the current choice of insert area for the chosen user.

3. Close (F7C3): To close the interface F7.

4. Insert Area Details (F7C2): Current locations of all designated insert areas of various users.

5. Mode of Insert (F7C5): This option indicates whether the host wants the insertions provided by the user to be merged into the main document automatically (i.e., the next time when the host opens the document, and if the user has provided the insertions, then the documents to show the merged data) or the host will manually merge the insertions.

6. Change Buttons (F7C6): These let the host change the choice of this row, and will invoke interface F11 (FIG. 16).

Interface F11 (FIG. 16)

This interface lets the host change the choice for the current Insert Area, and comprises the following interface elements (or controls):

1. Mode of Insert (F11C1): This lets the host change the current choice of insert mode. The previous mode of insert will appear here in auto-selected manner.

2. Close (F11C3): Closes the interface F11.

3. Apply (F11C4): Applies the choices of the host (i.e., any change in insert mode).

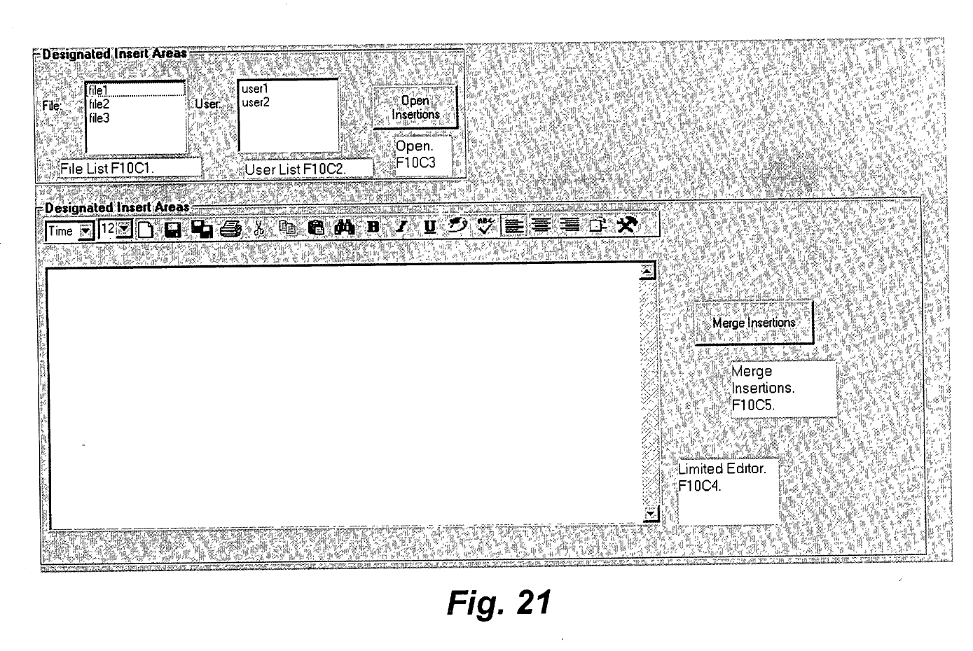

4. Revoke (F11C2): This revokes the right of this user to further do any inserts on the document on this area. This action will check if there are any insertions provided by the user for this part. If not, then it will just blindly deleted this right from that user. If so, then it will prompt the host to confirm that he/she wants to do so. Here, the host will be allowed to view that insertion first before taking any decisions. The message box shown in FIG. 17 will then be given. By clicking “Cancel”, no actions will be taken. Clicking “No” will delete the right from the user. Clicking “Yes” invokes interface F10 (FIG. 21) with auto-filled entries.

Specific Insert Area—Interface for Participants

For participants, some new interfaces will be presented to let them do their insertions into the designated documents by the host.

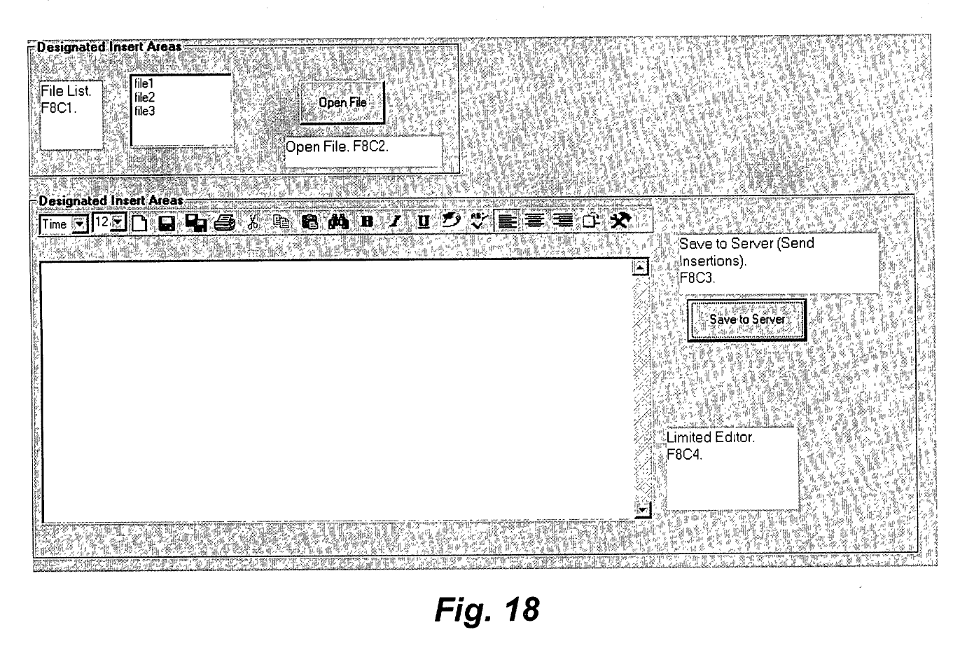

Interface F8 (FIG. 18)

This interface will be presented to a user for whom the host has designated an insert area in an archived session document. When this user goes to the Session Information page, then if there has been any such choice specified by the host, then this user will get the button “Prepare Insert Data” (which will invoke interface F8 as shown in FIG. 18). Interface F8 comprises the following interface elements (or controls):

1. File List (F8C1): This is the list of files (of the session concerned) for which host has specified at least one insert area for the current user.

2. Open File (F8C2): Clicking this button will open the chosen file from F8C1 into the editor F8C4.

3. Save to Server (F8C3): This sends the insertion of the current user as an archived document to server (to be merged with host document when host opens the document later).

4. Editor (F8C4): This is a limited feature editor. It will not offer any of the online features (e.g., close file). The file in the manner specified by the host will open in this editor (i.e., it might so happen that for this user, host has specified other EDIT rights also, so this file will open in this editor with all those rights imposed on it). The user will only be allowed to type in the designated areas of insertions. Either location or some image to be placed at the relevant position will identify these areas.

Interface F8 During the Session

During a session, for users for whom the host has specified a designated are of insertion of data, an additional button will appear on the right hand tab (Edit Rights). This button will read as “Prepare Insert Data”. Clicking this button will invoke interface F8. In addition to the button “Prepare Insert Data”, the user will also get an opportunity to insert data into master document in an ONLINE manner depending on host permission. For this, the host should have assigned the priorities on the order of inserts by the various users.

Host to Specify Priority of ONLINE Inserts

It might so happen that many users want to insert data into main host document in online manner. The host will get one additional button in the main right hand tab “Edit Rights” which will read as “Give Priority to Online Inserts”. Clicking this button will invoke interface F9 as shown in FIG. 19.

Interface F9 (FIG. 19)

This interface allows the host to specify the order in which users to put their insertions in an online manner, and comprises the following interface elements (or controls):

1. List of Ranks (F9C1): This is a growing list of sequential ranks. It is a static read only list.

2. List of Users (F9C2). Each combobox will hold list of all users. The host will have to specify rank of insert order to each user.

3. Apply (F9C3): Applies the current choices.

4. Close (F9C4): Closes Interface F9.

Insert Data: Host Opening a File

When the host opens the file in the main editor, it will be checked to determine if any of the users for whom the host had specified an auto-insert has provided with his or her insert data or not. If so, then the merge action will take place. If not, then the merge action will happen when host manually does this action. The interface F10 (FIG. 21) will let the host do manual merge actions.

Interface F10 (FIG. 21)

An additional button on right hand side tab (Edit Rights) can invoke this interface. This button will read as “Manual Merge of Inserts”. Hence, the right hand side tab of Edit Rights will show as depicted in FIG. 20. Interface F10 allows for manual merging of insertions, and comprises the following interface elements (or controls):

1. File list (F10C1): List of files for session for which at least one designated area of insert was specified earlier by host.

2. User list (F10C2): List of all users to whom the host had given an area of insert.

3. Open Insertion (F10C3): Opens the insertion of the chosen user on chosen file.

4. Merge Insertion (F10C5): Merges insertion of this user into the main document. If this interface F10 was invoked through F11C2 (FIG. 16), then at this stage, the right of this user for this part also to be deleted.

General Implementation Logic

The following description details the general implementation logic for the proposed modules as described above.

The Rights Information

With reference to this module (i.e., locking, hiding, insert area), the information of such attributes on the document has to reside at various points. The following points describe such storage points and the related bottlenecks that have to be resolved:

1. Off Session: When the host specifies Edit Rights before joining the Session, then all this information has to be stored in a remote database residing on a server. The information will be generated from various new ActiveX that are designed into this module. Hence, an efficient way of managing database at a remote machine needs to be taken into account.

2. On Session: When the host specifies Edit Rights within a Session, then information will be stored both in the database and within the editor ActiveX control. The storage of information within the editor ActiveX control will be governed by the following:

a. The editor at host node will always know all the details of all Edit Rights.

b. The editor at a user node only needs to know the information specific to it. Moreover this information will be only edit nature specific (i.e., only saying that certain range of data is locked or hidden etc.—who has hidden or locked is of no concern here).

A Web of Command Strings

As noted above, the term “Command String” was explained. Command Strings are strings carrying enough information to make sure that the edits do happen appropriately on the destination editor (i.e., cascading of edits happens).

Any edit that will happen on any node will reach all of the users' nodes (except for those specified not to receive edits). The nature of its execution on the destination editor will depend on the data of this command string (e.g., the location etc.) and the nature of rights pre-specified on the editor by host for that user. The following points are important:

1. The generation of edit command strings from editing node will change. It will carry the extra information of who is editing along with the information it carries as of the current structure. This information will be used at the execution end to check whether this users edit should be made visible at destination of not.

2. The various information edit right command strings may be stored as arrays or collections within the editor.

3. On each edit performed, the information described in point 2 above will be updated to the exact manner.

4. During execution of a command string on a destination editor, the nature of the destination location (i.e., as per the rights specified by the host) will decide the behavior of execution.

During the opening of a document, the document will be scanned for edit right logs. At this stage, the edit right logs array will be constructed. The various logs will be used to generate the RTF specification for saving the document. Edit right logs will contain the necessary information to indicate the preference of the host on the current document. These logs are updated at every edit action (both at host node and at users node) if needed, and are generated using the special control information logic to be used in this module.

Special RTF Control Information

Since the basic RTF specification does not provide the RTF control words that perform actions as needed for this module, a new set of control words/tables is needed for this module. The optional control word identifier “\*\” is used to embed these control words in the document. Accordingly, every time the document opens in the editor, it will be scanned for this optional control table, and appropriate logs will be made.

The following tables shall be used:

\*\lcktbl→to store the locking information

\*\hidtxttbl→to store the hiding of data information

\*\hidedittbl→to store the hiding of edits information

\*\instbl→to store the insert areas information

The information will be stored on session basis.

\*\lcktbl

This RTF control table will store the information necessary for bringing out the desired results in the Selective Locking of Data module. The general format of this control table is:

{\*\lcktbl {SessionID;pno1,lno1,cno1,pno2,lno2,cno2,ulist; . . . }[;] . . . }

Here,

SessionID is the Session ID of the session under consideration (the same document can store the right information for various Sessions—the host might want to specify the right information on the same document for various different Sessions for various users).

Pno1,lno1,cno1: Page NO., Line NO. within this page, and Char NO. within this line of the starting point of range.

Pno2,lno2,cno2: Page NO., Line NO. within this page, and Char NO. within this line of the ending point of range.

Ulist: comma separated list of all users that have been affected for the preceding range. Each session user should have a unique login ID.

The Scanning routine reads through this control table and builds a lock_data_array for the current session for the current document.

\*\hidtxttbl

This RTF control table will store the information necessary for bringing out the desired results in the Selective Hiding of Data. The general format of this control table is:

{\*\hidtxttbl {SessionID;pno1,lno1,cno1,pno2,lno2,cno2,ulist; . . . }[;] . . . }

Here,

SessionID is the Session ID of the session under consideration (the same document can store the right information for various Sessions—the host might want to specify the right information on the same document for various different Sessions for various users).

Pno1,lno1,cno1: Page NO., Line NO. within this page, and Char NO. within this line of the starting point of range.

Pno2,lno2,cno2: Page NO., Line NO. within this page, and Char NO. within this line of the ending point of range.

Ulist: comma separated list of all users that have been affected for the preceding range. Each session user should have a unique login ID.

The Scanning routine reads through this control table and builds a hide_data_array for the current session for the current document.

\*\hidedittbl

This RTF control table will store the information necessary for bringing out the desired results in the Selective Hiding of Edits module. The general format of this control table is:

{\*\hidtxttbl {SessionID;{ulistHide,userHide} . . . }[;] . . . }

Here,

SessionID is the Session ID of the session under consideration (the same document can store the right information for various Sessions—the host might want to specify the right information on the same document for various different Sessions for various users).

UlistHide: List of users who cannot see edits done by the specific user.

UserHide: User whose edits are to be made hidden for the UlistHide users. The Scanning routine reads through this control table and builds a hideedit_data_array for the current session for the current document.

\*\insttbl

This RTF control table will store the information necessary for bringing out the desired results in the Specific Area of Insert module. The general format of this control table is:

{\*\instbl {SessionID;{range,userInsert} . . . }[;] . . . }

Here,

SessionID is the Session ID of the session under consideration (the same document can store the right information for various Sessions—the host might want to specify the right information on the same document for various different Sessions for various users).

range: Range of the insert area.

userInsert: User for which the insert has been designated.

Each session the user has a unique login ID.

The Scanning routine read through this control table and builds an insert_area_array for the current session for the current document.

Main Landmarks

Pre-Session

1. Building arrays during document open;

2. Maintain array/update array during host editing the document; and

3. Merge array information into the document while saving the document.

During Session

1. Build Array during document open;

2. Merge array information with DATARTF when Whole Data is sent or send it separately;

3. Build array at Users node after getting Whole Data;

4. Maintain array/Update array at host node during edits (host/executing edits) this information is for all users;

5. Maintain array/Update array at Users node during edits (host/executing edits) this information is for self;

6. Display-updating at the host node;

7. Build array/Update array/Maintain array at host node for host's choices in TABS;

8. Generate Command String for 7;

9. Execute Command String of 7 at Users node;

10. Build array/Update array/Maintain array at Users node on receiving Command Strings;

11. Filter Execution of other edits by USERS on their editors as per array.

Selective Hiding and Locking of Text (ON SESSION)

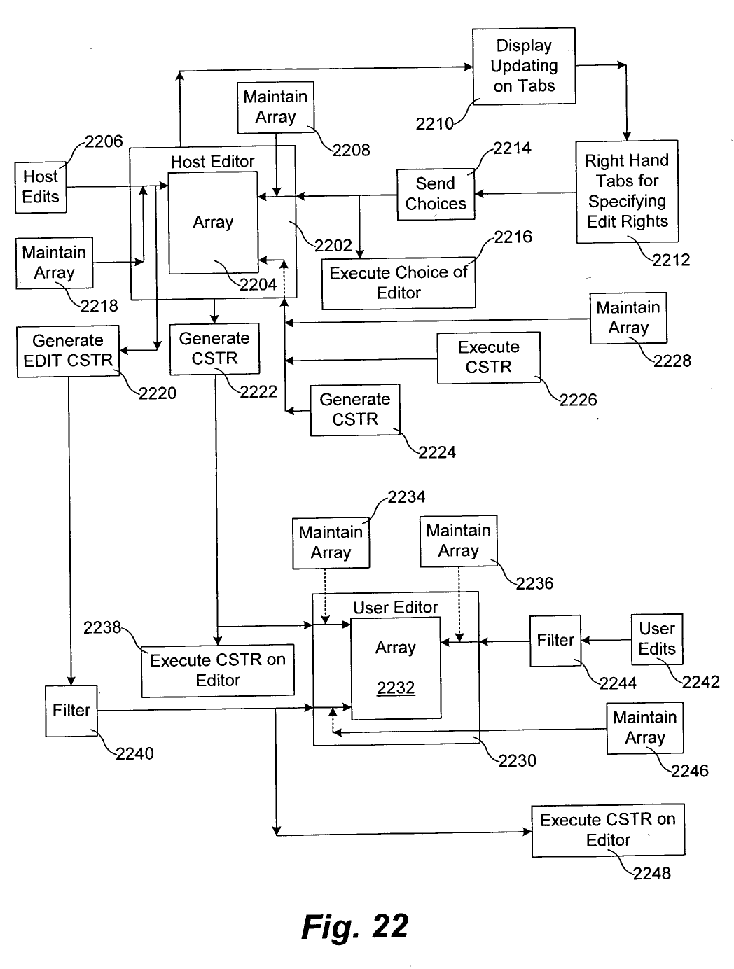

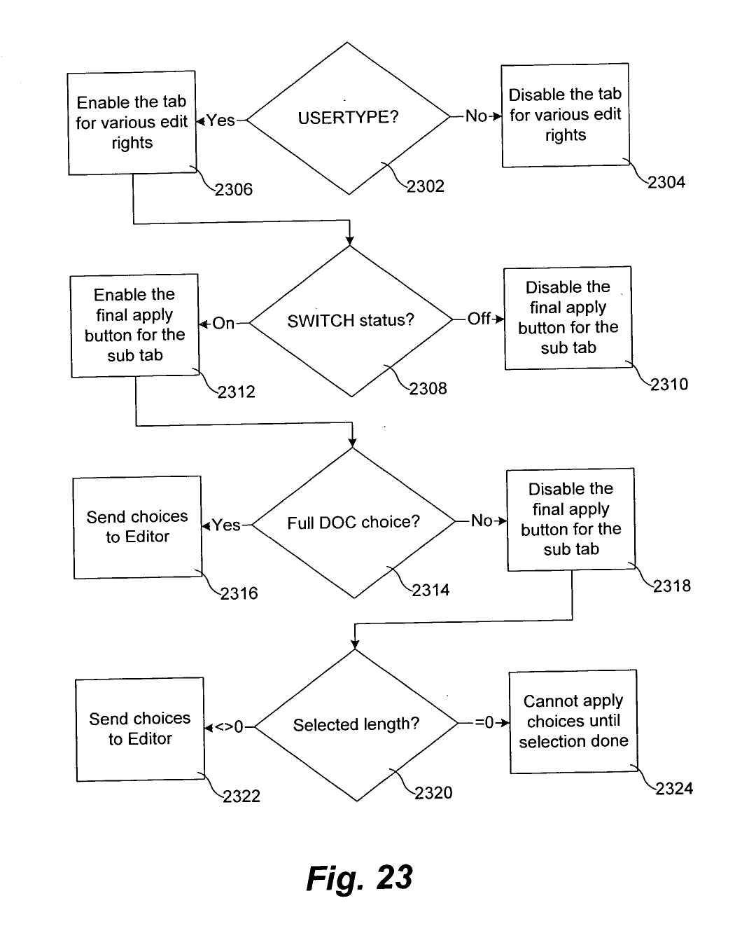

FIG. 22 is a data flow diagram, which depicts the various entities involved and the flow of information through the system 100. Certain prerequisites must be met. For example:

1. A list of all users for the conference must be made available to the host at all times, whether the USERS are online or offline.

2. Login IDs should not include special characters (e.g., ;″: etc.).

3. Login IDs should be stored as lowercase in the database of system 100.

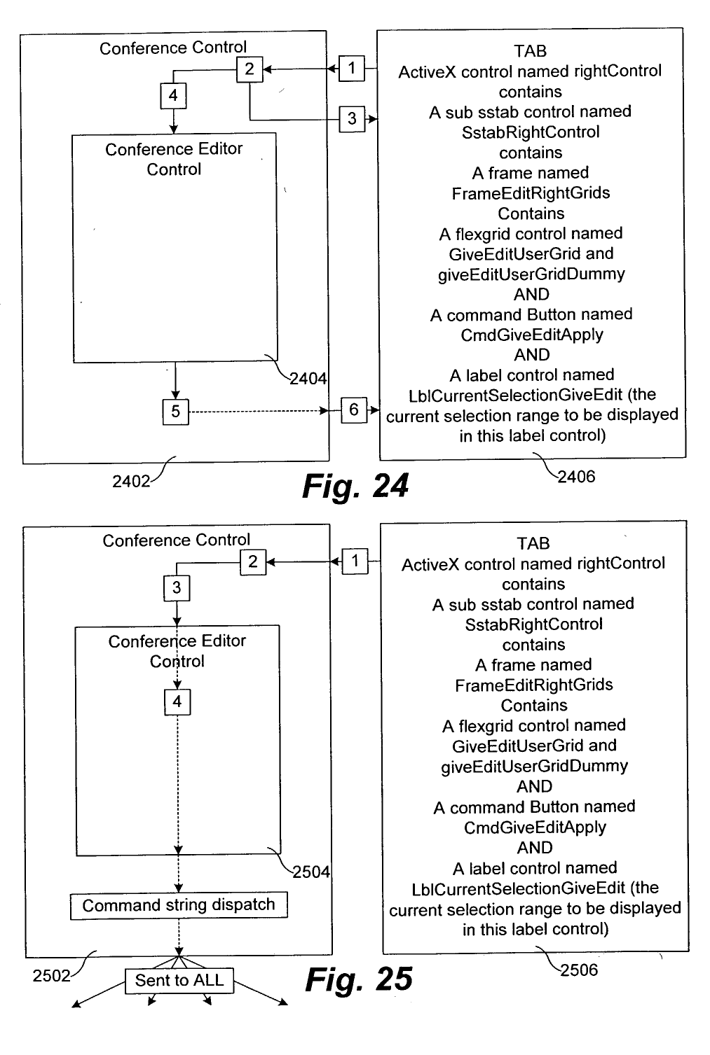

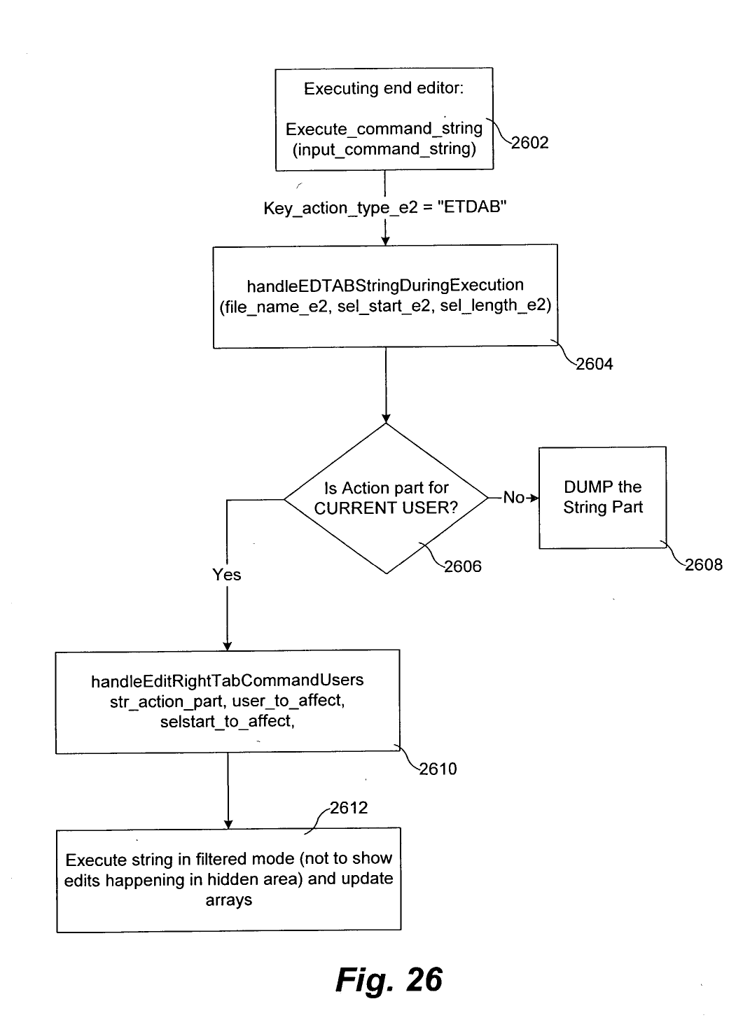

Referring now to FIG. 24, it can be seen how information travels from tabs through Switch Notes Conference Control 2402 to the editor and back for updating the information on the Edit Right Tabs. Block 1 indicates a request from TABS 2406 to the editor 2404 for information. Block 2 is an event trap for the request made by block 1. Block 3 indicates a passing of information back to rightControl about the switch status of current user. This procedure further disables or enables the apply button in the rightControl. Block 4 calls the public sub of conference editor to ask for the information. rtfcontrol1.TabsAskingForlnfo (pass the tab number→different tabs will need different types of information→hence this tab number is passed). Block 5 reads through the arrays and sends back the information. Block 6 indicates a procedure which reads the information received and updates the display of LblCurrentSelectionGiveEdit and GiveEditUserGrid.

Referring now to FIG. 25, it can be seen how information travels from tabs through Switch Notes Conference Control 2502 to the editor and back for updating the grid of the Edit Right→Give Edit Rights sub Tabs for the current Range. Block 1 indicates the host choices. Block 2 is an event trap for ChoicesFromEditTabToEditor. Block 3 is a STRING received from tabs: rtfcontroll.RecvChoicesFromEditTabToEditor. Block 4 is a procedure which will update the various arrays as per the choices received and will execute the choices on the host editor to change the color/appearance of host editor. This procedure will also generate the Command String to go to ALL users. The String of interest (i.e., the same string that came from tabs) is passed through in this Command String. The special parameter that will represent this Command String as an Edit Right tab command string is “EDTAB”.

Execution End—Execution

At the end of execution, the EDTAB Command String is interpreted in a different way as shown in FIG. 24. The array information stored at all users' nodes is only for them only. So, the Tab String that came in file_name_e2 will only be processed in the executing end editor IF it is for current USER else it will be dumped. The following abbreviations may have been used in describing the system 100:

FL—Full Lock

FH—Full Fide

SL—Selective Lock

SH—Selective Hide

FLO—Full Lock Off

FHO—Full Hide Off

SLO—Selective Lock Off

SHO—Selective Hide Off

These tags (or identifiers) are attached with the Command Strings. The username for which the flag is supposed to act is also attached alongside. For example, FH:user1 would mean that a full hide command has been issued for user1. These commands act under the following rules:

1. If FL chosen then SL has no meaning for the same user;

2. If FH chosen then SH has no meaning for the same user;

3. If FLO chosen then SLO has no meaning for the same user; and

4. If FHO chosen then SHO has no meaning for the same user.

Selective Hiding of Parts of Documents

This tool allows the Host to specify different areas in the document hidden for different users in the session. This allows the host to show the document to others on a “Need to Know” basis.

As described herein above with respect to the implementation of hide edit rights, the part of the document to be hidden was just made invisible and locked for the invitee. In accordance with a presently preferred embodiment of the invention, a new concept of Delta Numbering has been introduced. The following explains this concept of Delta Numbering and also presents the concept of Hide Edit Rights for other types of documents (e.g., graphics, and spreadsheets).

Delta Numbering

In previous embodiments, the basic assumption for the Switch Notes Instant Editor to work properly was that all documents opened in the Switch Notes Instant Editor of all participants of a session are exactly same. That is all edits from the editing user are cascaded to other users using a unique identifying characteristic called SelStart (i.e., the position of current cursor position). Each edit raises a command (known as command string) and it carries enough information with it to make sure that the Switch Notes Instant Editor at the receiving end does proper execution (i.e., place the cursor position to the particular position and do the proper edit).

In the present embodiment, executions of edits from the editing user to the receiving user can still happen if the two documents are not the same. This difference of documents is produced by a Hide Action done by the host on some part of the document for an invitee. As described earlier in regards to Edit Rights, the host chooses (or selects) the part of the document that he or she wants to hide for an invitee, and chooses the Part Hide option from the Edit Rights tab. As a result, an EDTAB command string with SH (Selective Hide) parameter is released for the invitee.

The logic for maintaining hide edit rights has been changed only at the invitee side (i.e., on the ends of the users for who hide edit areas have been defined). The logic for host-side hide edit rights maintenance remains the same as in earlier embodiments. The logic for Unhide has changed at the host side in the manner described herein below.

On the receiving side, when an SH command string is received, the following actions are carried out:

1. Filter the command string

2. Select the area to be made hidden

3. Perform an absolute delete of the selected area and update the hidden area logs (this creates a Void for this invitee).

A new log is maintained at the invitee side for this implementation of hide edit rights. This log is termed the Void area log. This log contains two values per element:

Selst_void, SelLen_void

where

Selst_void is the SelStart of the void (i.e. the hidden area), and

SelLen_void is the length of the void.

Hence, after an SH operation has been performed,

Host Document Minus the contents in the Void area=Invitee document

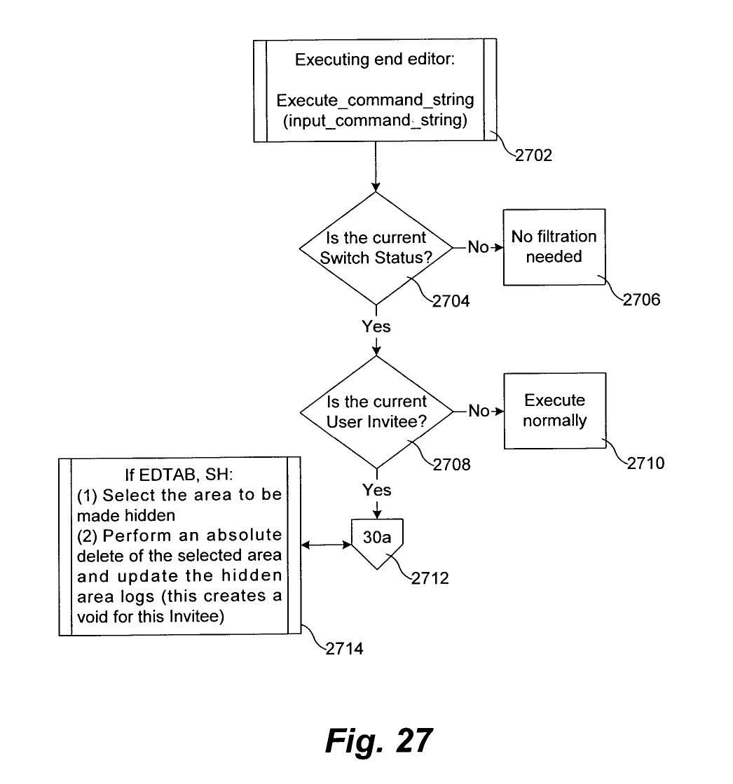

The flow chart shown in FIG. 27 explains this process of creating a void.

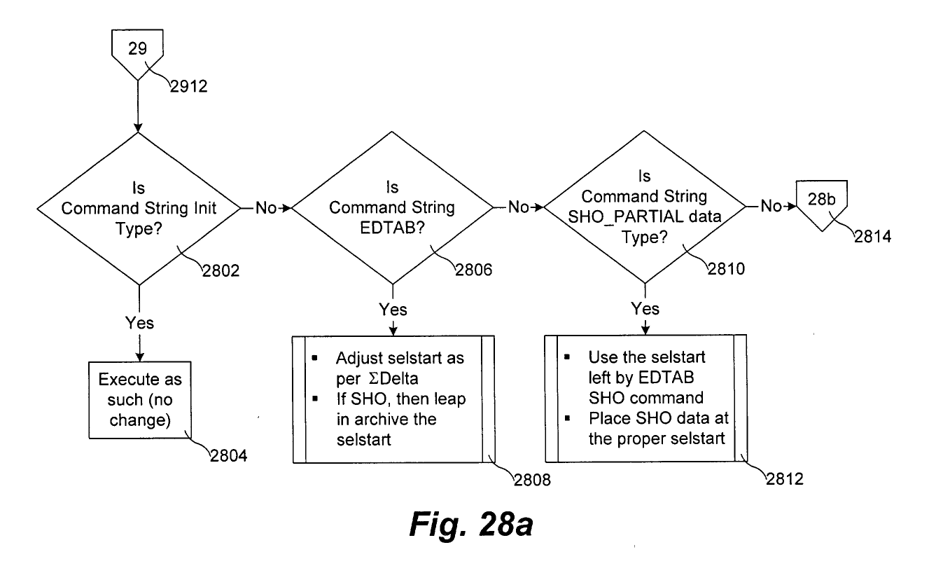

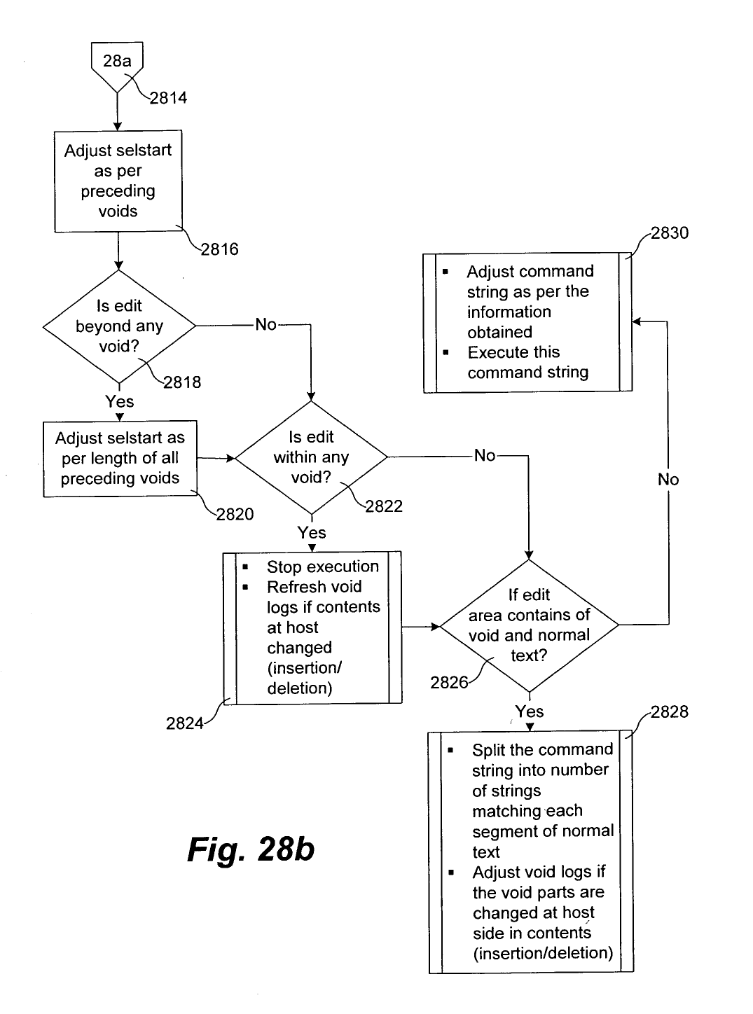

After the void has been created, each command string that will come for execution on the invitee editor will go through a Command String Filter to readjust the values in the Command String. This will make sure that the executions now happen at the correct referential position. The flow chart shown in FIGS. 28a-28b explain this process of Command String Filtering.

Similarly, the command string created due to any edit that an invitee does from now onwards will also go through a Command String filter to make sure that this command string is refreshed as per the contents of the Host document (the original). The flow chart shown in FIG. 30 explains this Command String filtering.

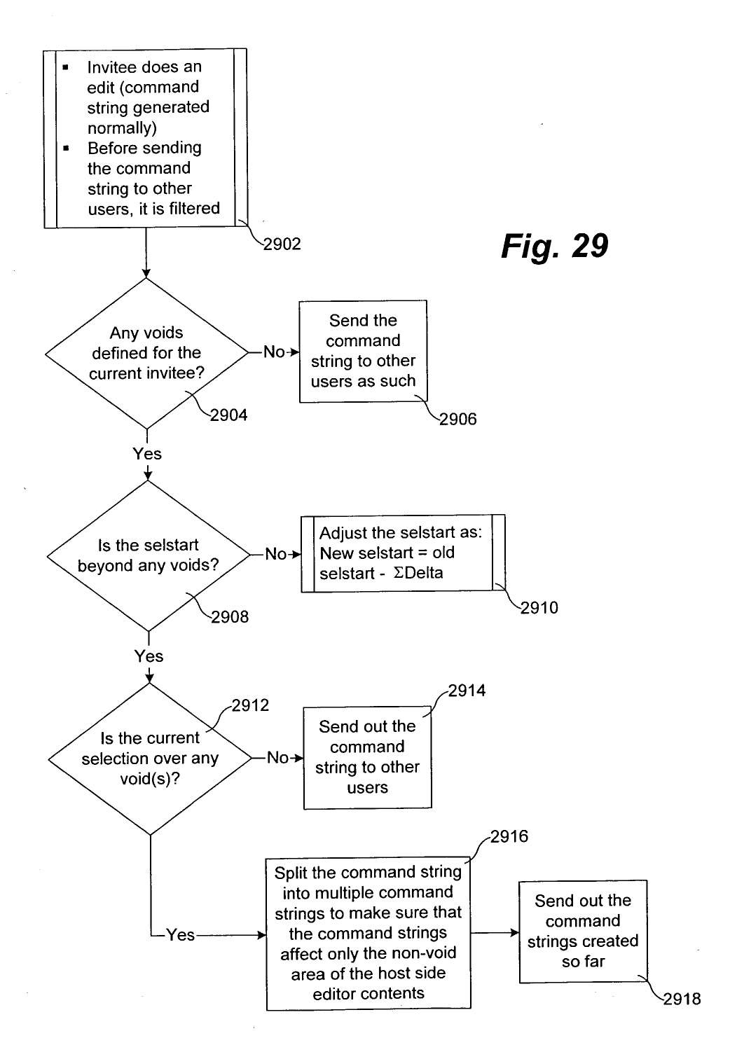

If no hide areas are defined for an invitee, then neither processes shown in FIGS. 28a-28b or FIG. 29 are executed for that invitee. The processes shown in FIGS. 28a-28b or FIG. 29 come into play only when there is at least one Void present for that invitee.

Here, on receiving the Command String, first it is checked if it the current Switch is Red, then if the current is INVITEE, the command string is filtered for matching it with the contents of the invitee's editor (FIGS. 28a-28b). The process shown in FIGS. 28a-28b returns a changed (if needed) command string to do the execution on the receiving editor.

Here, the incoming command string is first checked for its type. If it is an Init (initialization) command string, then no filtering is needed. If it is an EDTAB command string, then its contents have to be matched to the contents of the invitee editor. The SelStart of the command string is changed to a new one as per the following formula:

New SelStart=old SelStart+ΣDelta

where ΣDelta is the sum total of void lengths that occur before the SelStart of execution. If the command parameter is SHO (selective Hide Off), then to keep in archive the SelStart of current execution.

If the command string is SHO_Partial type, then the SelStart left over by the EDTAB SHO command is used to place the SHO data at the proper place.

If the command string is normal edits, then first the SelStart is updated by using the same ΣDelta formula. After that, the following cases might arise:

1. Edits are to happen within a Void area: In this case, the command string is to be ignored from execution, but the effect of the execution on the void logs has to be refreshed (i.e. host side the void might have increased or decreased in length).

2. Edits are to happen with the void as a part of the selection. In this case, the command string is to be split into the number of normal text segments that the selection has. This means that the execution should only happen on the text that is not marked as hidden for this invitee. Accordingly, any insertions or deletions done at host side in the void areas are to be updated in the void logs at the invitee side.

3. Edits will not affect any void area at all. This means that the execution can be allowed.

A new command string, or set of command strings (if trapped in any of the void area conditions), will be produced and passed over to the editor for execution.

Here, the command string is first generated normally due the edits done by the invitee. If there are no voids defined for the current user, then the command string is sent out as such to the other users. But, if there are voids defined for the current user, then:

1. The SelStart of the current command string has to be updated as per the following formula:

New SelStart=old SelStart−ΣDelta

where ΣDelta is the sum total of void lengths that occur before the SelStart of edit.

2. If the current selection of edit contains any void in it, then the command string is split into multiple command strings to make sure that the edits happen on the host side on only the non void areas. Hence, for example a bold action done on a selection at invitee which contains one void, two command strings will be issued that will make the text to the left and right of the host side hidden area as bold.

After the generation and updating of SelStart of the command strings, they are sent out to the other users for execution.

Host Side—Unhide

On the host side, a change as been done in the logic of unhide. Now, the unhide operation is very much like a paste operation for the unhidden part of the document. This is used when the host selects part of a hidden area and wishes to unhide it:

1. The RTF text of the selection is extracted; and

2. It is sent to the invitee under consideration as a SHO_PARTIAL data command string.

Hide—Graphics and Spreadsheets

The following describes how the hide edit rights can be implemented on the graphics and spreadsheet version of Switch Notes. Graphic Switch Notes works on concept of coordinates in the canvas area. All edits are cascaded as a reference to the coordinates of the edit area. When the host of the session wishes to hide a certain part of graphic document, the hide command string when executed on the invitee side will remove the area of selection from the canvas and will leave behind a visible void. This can be distinguished from the text version of Switch Notes in which the voids were invisible. All other edits that come from the host now for coordinates which are not in the void happen as such, but if they are in the void, then they are to be ignored for execution.

Spreadsheets work with reference to the cell address. All edits are cascaded with reference to the cell address of the edit. When the host of the document wishes to hide a certain range of a sheet, then on receiving the hide command string at the invitee node, this range of cells will be made blank (i.e., will have no data). All edits after this creation of hide area will be carried out only if the hide area is not to be affected.

Multi-Tracking Feature in Switch Notes

Switch Notes is the only conferencing application that offers the feature of “multitracking”. Multitracking allows for a document to be revised by various users in a Switch Notes session—thereby recording all insertions or deletions done by all users—each user being given a unique color.

The colors are assigned to each user in order of color intensity so that each user gets a different and easily distinguishable color. It also ensures that no user gets a black color. Once the host of the session turns the tracking feature ON, all insertions and deletions done by anyone in the session are marked with the corresponding revision mark. An appropriate tool tip displaying the timestamp and edit details is flashed when the mouse is brought over such a tracked area of the document.

All tracking information is also retained when the document is saved. If the same document is opened in an external word processor that supports Revised Changes functionality of RTF specifications, then it is able to read all the tracking information saved from a Switch Notes session. Switch Notes Instant Editor also has the ability of reading a pre-tracked document and displaying all revised changes information when it opens in Switch Notes Instant Editor.

The operational rules of tracking are followed while editing is done with tracking option turned ON. The important rules are:

1. All insertions to be underlined and colored with the color assigned to the user having the switch.

2. All deletions (over pre-existing normal text or over a tracked insertion done by some other user) to come as striked and colored with the color assigned to the user having the switch.

3. All deletions (over tracked insertion done by the user having the switch) to delete the text absolutely.

4. Rules 1, 2, 3 to apply in accordance with the nature of the text if insertion or deletion attempted over a text section that has mixed attributes (i.e., some text pre-tracked insertion and some normal).

SwitchSpread—The Online Spreadsheet Editor

SwitchSpread is a technology that can allow the real-time online editing functionality on a spreadsheet document. The SwitchSpread editor supports a variety of edit functions including, for example, typing, formatting, (e.g., bold, italic), formulas and clipboard operations (e.g., cut, replica, paste), and operations that respond to keyboard and mouse events, operations performed via a toolbar, and operations performed via a mouse click. The editor determines where an edit occurred and also determines the properties of the edit (e.g., color, font, format, etc.) It also supports opening and saving of files that include spreadsheet formatted data. The editor may further include a speech recognition feature. The editor opens spreadsheet files such that the location of each character of a file is uniquely identifiable (by the cell address—each cell is identified by a cross section of a particular row and a column). The cascading process receives an edit from a marked place of a file and sends the edit to the same marked place of a replica of the file.

Once the file is opened in this editor, it is sent to all allowed invitees in the session sheet by sheet and all the sheets being received on the invitee's ends are displayed to them sheet by sheet.

The nature in which the edits are registered and cascaded to invitee end sheets is based on the kind of edit:

1. If edit is of normal insertion/deletion/formatting/clipboard operation, then the edits are cascaded on change by change basis (i.e., on each change within the cell).

2. If edit is of formula type, then the edit is registered and cascaded only when the current cell looses focus.

Although the present invention has been described in regards to several embodiments, those of ordinary skill in the art will appreciate that this description is merely exemplary and the system and method of this invention may include additional or different components. The means for hiding parts of a document, for example, may be applicable to different parts of the document for different users. Moreover, the systems and methods according to the present invention may apply to other implementations and technologies (e.g., wireless) which do not require a command string. Only the appended claims and the full scope of their equivalents, therefore, are deemed to limit the foregoing description.

What is claimed is:

1. A system to edit a document in an application over a network, comprising:
a first client, which includes a first document in the application and a first editor that allows a user of the first client to access a replica of a second document;
a second client, which includes said second document and a second editor that allows the second client to access a replica of said first document; and
a server that provides said first client and said second client with simultaneous access to the replicas of said first and second documents;
wherein said first editor and said second editor each include:
first means for performing typing, formatting and clipboard operations on said first and second documents; and
second means for performing operations on said first and second documents that respond to keyboard and mouse events.

2. The system according to claim 1, wherein said second performing means comprises:
means for performing operations on said first and second documents via a toolbar; and
means for performing operations on said first and second documents via a mouse click.

3. The system according to claim 1, wherein said first editor and said second editor further comprise:
first means for determining where an edit occurred in said first and second documents; and
second means for determining a plurality of properties of said edit.

4. The system according to claim 3, wherein said second determining means comprises means for determining a color, font, and format of said first and second documents.

5. The system according to claim 1, wherein said first editor and said second editor further comprise means for recognizing speech.

6. The system according to claim 1, wherein said first editor and said second editor further comprise means for opening and saving said first and second documents that include both formatted and non-formatted text.

7. The system according to claim 1, wherein said first editor and said second editor further comprise means for opening said first and second documents in a rich text file (RTF) format such that a location of each character of said first and second documents is uniquely identifiable.

8. The system according to claim 7, further comprising means, responsive to a receipt of an edit command, for performing said edit on the replica of said first document or said second document on which said edit is made and subsequently making the same change in the same location on all corresponding replicas.

9. The system according to claim 1, wherein said first editor and said second editor further comprise means for opening said first and second documents in a spreadsheet format including a plurality of cells, wherein each said cell of said first and second documents is marked according to a unique identifier corresponding to a cell address.

10. The system according to claim 1, wherein said first editor and said second editor further comprise means for opening said first and second documents in a graphics format including a plurality of lines, wherein each said line is marked according to a unique identifier corresponding to its respective screen coordinates.

11. The system according to claim 1, wherein said first editor and said second editor further comprise means for cascading said edit such that an edit from a marked place of said first and second documents and sends said edit to the same marked place of a replica of said first and second documents.

12. The system according to claim 1, further comprising means for specifying a plurality of rights to edit said first and second documents.

13. The system according to claim 12, wherein said specifying means further comprises:
means for selectively locking data within said first and second documents;
means for selectively hiding data within said first and second documents;
means for selectively hiding edits within said first and second documents;
means for defining user-specific edit areas within said first and second documents;
means for tracking changes within said first and second documents; and
means for pre-defining insert areas within said first and second documents.

14. The system according to claim 13, further comprising a host, an editing user and a receiving user, and said means for selectively locking data, said means for selectively hiding data, and said means for selectively hiding edits are each adapted to be able to lock and hide different parts of said first and second documents from different users of said first and second documents.

15. The system according to claim 1, further comprising a host, an editing user and a receiving user wherein said first and second documents are not the same, and the system further comprises means for executing edits from said editing user to said receiving user, whereby the difference of said first and second documents is produced by a hide action done by said host on a selected part of said first or second documents for an invitee.

16. The system according to claim 15, further comprising means for performing said hide action including:
first host means for choosing said selected part to hide from said invitee;
second host means for partially hiding said selected part; and
means for releasing a command string with a selective hide parameter for said invitee.

17. The system according to claim 15, further comprising at said client of said receiving user:
means for filtering said command string;
means for selecting an area to be made hidden; and
means for performing an absolute delete of said selected area and updating a hidden area log which creates a void for said invitee.

18. The system according to claim 1, wherein said first and second clients and said server each comprise computing means selected from the group consisting of a general purpose computer; personal computers (PCs); web browsers; electronic mail (e-mail) clients and servers; network file and messaging servers; mainframes; Internet appliances; wireless telephones; pagers; personal digital assistants (PDAs); facsimile machines; digital still and video cameras; digital voice and video recorders; digital copiers or scanners; interactive television; a hybrid combination of any of the above computing means and an interactive television; and any apparatus comprising a processor, memory, the capability to receive input, and the capability to generate output.

19. The system according to claim 1, further comprising means for multitracking said first and second documents to be revised by all users in a system, thereby recording all insertions or deletions done by all users, each said user being given a unique color.

20. An online document editing method, comprising:
providing at least two users with simultaneous access to a document such that each user has access to a replica of said document;
providing one of the at least two users with a capability to edit a local replica of said document; and
automatically cascading said edit to all of the replicas of said document.

21. The method according to claim 20, further comprising a transferring of the capability to edit a local replica of said document to an other of the at least two users.

22. An online document editing method, comprising:
uploading said document from a first client to a server;
providing to said first client and a second client simultaneous access to a first replica and a second replica, respectively, of said document;
receiving from one of said first client and said second client an edit command to edit one of said first replica and said second replica;
editing the one of said first replica and said second replica of said document according to said edit command; and
automatically editing an other of said first replica and said second replica of said document according to said editing of the one of said first replica and said second replica of said document such that said editing is performed at a same location of the other of said first replica and said second replica of said document as it was performed in the one of said first replica and said second replica of said document.

23. The method according to claim 22, further comprising providing to one of said first and second client authority to edit said document.

24. The method according to claim 22, further comprising providing to one of said first and second clients authority to save said document.

25. The method according to claim 22, further comprising the step of providing said document from an application selected from the group consisting of word processing applications, presentation applications, spreadsheet applications, graphics applications, imaging applications, computer-aided drafting applications, holographic applications, two-dimensional applications, and three-dimensional applications.

26. The method according to claim 22, further comprising the step of providing means for specifying a plurality of rights to edit said first and second documents.

27. The method according to claim 22, further comprising the steps of providing:
means for selectively locking data within said first and second documents;
means for selectively hiding data within said first and second documents;
means for selectively hiding edits within said first and second documents;
means for defining user-specific edit areas within said first and second documents;
means for tracking changes within said first and second documents; and
means for pre-defining insert areas within said first and second documents.

28. The method according to claim 27, further comprising the steps of providing a host, an editing user and a receiving user, and providing said means for selectively locking data, said means for selectively hiding data, and said means for selectively hiding edits with an ability to lock and hide different parts of said first and second documents from different users of said first and second documents.

29. The method according to claim 22, further comprising the steps of providing:
a host;
an editing user; and
a receiving user,
wherein said first and second documents are not the same, and the method further comprises the step of providing means for executing edits from said editing user to said receiving user, whereby the difference of said first and second documents is produced by a hide action done by said host on a selected part of said first or second documents for an invitee.

30. The method according to claim 29, further comprising the steps of providing means for performing said hide action including:
first host means for choosing said selected part to hide from said invitee;
second host means for partially hiding said selected part; and
means for releasing a command string with a selective hide parameter for said invitee.

31. The method according to claim 29, further comprising the steps of providing at said client of said receiving user:
means for filtering said command string;
means for selecting an area to be made hidden; and
means for performing an absolute delete of said selected area and updating a hidden area log which creates a void for said invitee.

32. The method according to claim 22, further comprising the steps of:
providing means for multitracking said first and second documents to be revised by all users in a system, thereby recording all insertions or deletions done by all users, each said user being given a unique color;
underlining and coloring all insertions with the color assigned to the user having a switch;
striking and coloring all deletions over pre-existing normal text or over a tracked insertion done by an other user with the color assigned to said user having said switch; and
deleting the text absolutely all deletions over a tracked insertion done by said user having said switch.

33. The method according to claim 32, further comprising the step of applying said underlining and coloring step, said striking and coloring step, and said deleting step in accordance with the nature of the text if said insertions or deletions attempted over a text section has mixed attributes.

34. The method according to claim 22, further comprising the steps of providing at said first and second clients and said server computing means selected from the group consisting of a general purpose computer; personal computers (PCs); web browsers; electronic mail (email) clients and servers; network file and messaging servers; mainframes; Internet appliances; wireless telephones; pagers; personal digital assistants (PDAs); facsimile machines; digital still and video cameras; digital voice and video recorders; digital copiers or scanners; interactive television; a hybrid combination of any of the above computing means and an interactive television; and any apparatus comprising a processor, memory, the capability to receive input, and the capability to generate output.
